(19) United States
(12) Patent Application Publication
(10) Pub. No.: US 2026/0191145 A1
(43) Pub. Date: Jul. 9, 2026

(54) REMOTE OPERATED VEHICLE FOR CLEANING GRAIN BINS

(71) Applicant: Jared Burma, Waukee, IA (US)

(72) Inventor: Jared Burma, Waukee, IA (US)

(21) Appl. No.: 19/439,600

(22) Filed: Jan. 5, 2026

Related U.S. Application Data
(60) Provisional application No. 63/742,217, filed on Jan. 6, 2025.

(51) Int. Cl. A01F 25/20; A46B 5/00; A46B 13/00; A46B 13/02; B60K 1/02; B62D 55/06; B65G 53/24; B65G 65/38; B65G 65/46; G05D 1/221; G05D 107/50

(52) U.S. Cl. CPC A01F 25/2018; A46B 5/0012; A46B 13/008; A46B 13/02; B65G 53/24; B65G 65/38; B65G 65/46; G05D 1/221; A46B 2200/3006; B60K 1/02; B62D 55/06; B65G 2201/042; G05D 2107/50

(57) ABSTRACT

In one or more arrangements, a system and method for cleaning a grain bin using a remote operated vehicle is presented. In one or more arrangements, the grain bin is emptied until the grain will no longer flow from the grain bin using conventional pumps and conveyors. In some arrangements, a remote operated vehicle is configured to be piloted through a door in a grain bin once grain has been removed from adjacent the door. In some arrangements, the remote operated vehicle has a foldable head assembly configured to fold and unfold to facilitate entry and removal of the remote operated vehicle through the door of the grain bin. In some arrangements, the remote operated vehicle is operably connected to a grain vacuum to facilitate removal of grain from the grain bin. In some arrangements, the remote operated vehicle can be remotely piloted to facilitate removal of grain.

### CROSS-REFERENCE TO RELATED APPLICATIONS

This application claims priority to U.S. Provisional Application 63/742,217, titled “REMOTE OPERATED VEHICLE FOR CLEANING GRAIN BINS”, and filed Jan. 6, 2025, the entirety of which is hereby incorporated by reference herein, including any figures, tables, drawings, or other information.

### FIELD OF THE DISCLOSURE

This disclosure relates to grain storage devices used in agriculture. More specifically and without limitation, this disclosure relates to grain bins.

### OVERVIEW OF THE DISCLOSURE

Grain bins are massive structures used to store bulk flowable grain products such as corn, soybeans, wheat, rice, and/or any other grain products or other material. Conventional grain bins are generally formed in a cylindrical shape with a corrugated sidewall covered by a peaked roof. Grain bins vary in height (ranging from twenty feet high to over a hundred and fifty feet high, or higher). Grain bins vary in diameter, (ranging from eighteen feet in diameter to over a hundred and fifty feet in diameter, or larger). The storage capacity of modern grain bins can range anywhere from a few thousand bushels to well over two million bushels.

Grain bins may be unloaded in various ways. Many grain bins include a generally centrally positioned sump that facilitates removal of grain from the grain bin by a transport positioned below the floor. While this configuration is effective at removing most of the grain from a grain bin, using a centrally positioned sump alone leaves a coned ring of grain that cannot be removed by a centrally positioned sump alone.

To avoid manually shoveling this coned ring of grain out of the grain bin, in many applications sweeps are used. When operated after a majority of grain has been removed via the center sump, sweeps travel around the grain bin and help to move grain towards the centrally positioned sump so that the grain may be removed by the sump.

In some applications, temporary sweeps are used. Temporary sweeps require the user to manually install the sweep into the grain bin and uninstall the sweep after use. However, installing and removing a temporary sweep is an undesirable, tedious, difficult and dangerous task.

To avoid manually installing and manually removing temporary sweeps, various configurations of “zero entry sweeps” have been developed. Zero entry sweeps are configured to remain in the grain bin when it is filled thereby eliminating the need to enter the grain bin to install or remove the sweep from the grain bin. Hence the name “zero entry” as users are not required to enter the grain bin. While zero entry sweeps provide a number of advantages, there are a number of challenges associated with the use of zero entry sweeps. These challenges are exasperated when attempting to provide a zero entry sweep with a grain bin having an elevated floor. This is especially true for larger grain bins that require larger sweeps. Furthermore, respective zero entry sweeps must be provided for each grain bin, significantly increasing equipment costs.

Therefore, for all the reasons stated above, and all the reasons stated below, there is a need in the art for an improved system for cleaning grain bins.

Thus, it is a primary object of the disclosure to provide a remote operated vehicle based system for cleaning grain bins that improves upon the state of the art.

Another object of the disclosure is to provide a remote operated vehicle based system for cleaning grain bins that reduces or eliminates the need for a user to enter the grain bin.

Yet another object of the disclosure is to provide a remote operated vehicle based system for cleaning grain bins that effectively removes the vast majority of grain from the grain bin.

Another object of the disclosure is to provide a remote operated vehicle based system for cleaning grain bins that is efficient to use.

Yet another object of the disclosure is to provide a remote operated vehicle based system for cleaning grain bins that reduces equipment costs.

Another object of the disclosure is to provide a remote operated vehicle based system for cleaning grain bins that can be used with any grain bin.

Yet another object of the disclosure is to provide a remote operated vehicle based system for cleaning grain bins that that works effectively.

Another object of the disclosure is to provide a remote operated vehicle based system for cleaning grain bins that is robust.

Yet another object of the disclosure is to provide a remote operated vehicle based system for cleaning grain bins that is durable.

These and other objects, features, or advantages of the disclosure will become apparent from the specification, figures and claims.

### SUMMARY OF THE DISCLOSURE

In one or more arrangements, a remote operated vehicle based system is presented for cleaning grain bins. In one or more arrangements, the system includes a grain vacuum, a remote operated vehicle, and a vacuum hose fluidically connecting the remote operated vehicle to the grain vacuum.

In one or more arrangements, the remote operated vehicle includes a chassis, a drive system, a head assembly and an air passageway assembly. In one or more arrangements, the head assembly is operably connected to the chassis and has an elongated body with an open front and a rearward opening. The head assembly includes a grain conveyor positioned within the elongated body that is configured to move grain that enters the elongated body to the rearward opening. The air passageway assembly is configured to provide a fluidic connection between the rearward opening and the vacuum hose to facilitate removal of grain through the air passageway assembly and vacuum hose by way of vacuum.

In one or more arrangements, the head assembly is foldable to facilitate movement of the remote operated vehicle through a doorway of a grain bin and unfold once inside the grain bin. In one or more arrangements, the remote operated vehicle includes a lift assembly configured to move the head assembly between an upper position and a lower position. In one or more arrangements, the remote operated vehicle includes one or more brush assembly, positioned at an outward end of the head assembly, that are configured to direct grain into the path of the head assembly.

### BRIEF DESCRIPTION OF THE DRAWINGS

FIG. 1 is a plan view of a system for cleaning a grain bin, in accordance with one or more embodiments; the view showing a remote operated vehicle, a grain bin, a grain vacuum, a hose, an actuated hose coil, and a control system, among other components.

FIG. 2 is a plan view of a system for cleaning a grain bin, in accordance with one or more embodiments; the view showing a remote operated vehicle, a grain bin, a grain vacuum, a hose, an actuated hose coil, and a control system, among other components.

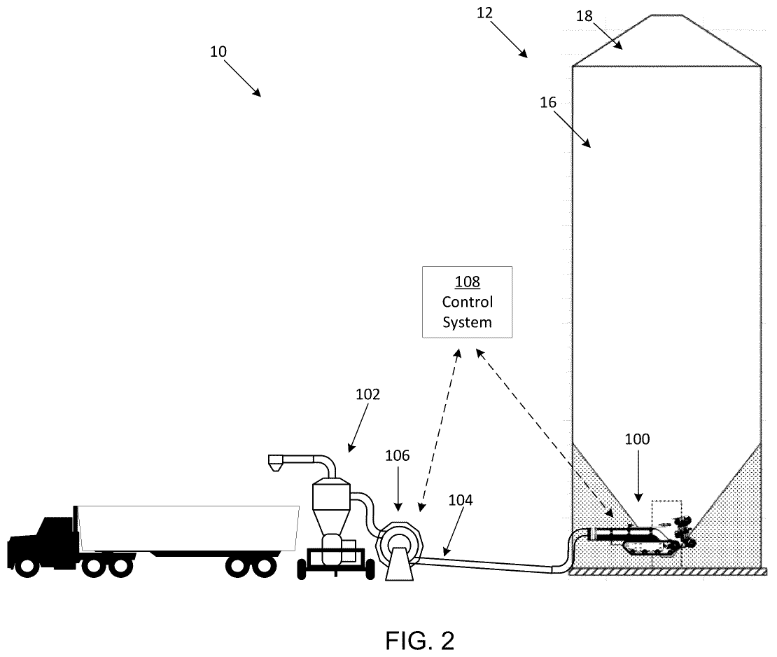

FIG. 3 is a front elevation view of a remote operated vehicle of a system for cleaning a grain bin, in accordance with one or more embodiments; the view showing a chassis, a foldable head assembly, extended brush assemblies, and sensors, among other components.

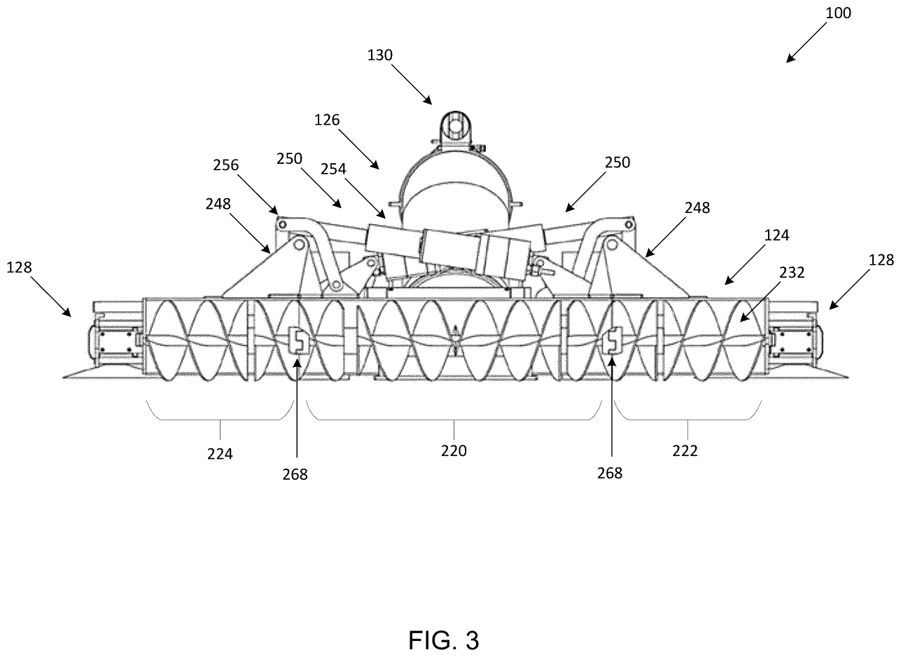

FIG. 4 is a front elevation view of a remote operated vehicle of a system for cleaning a grain bin, in accordance with one or more embodiments; the view showing a chassis, a foldable head assembly, retracted brush assemblies, and sensors, among other components.

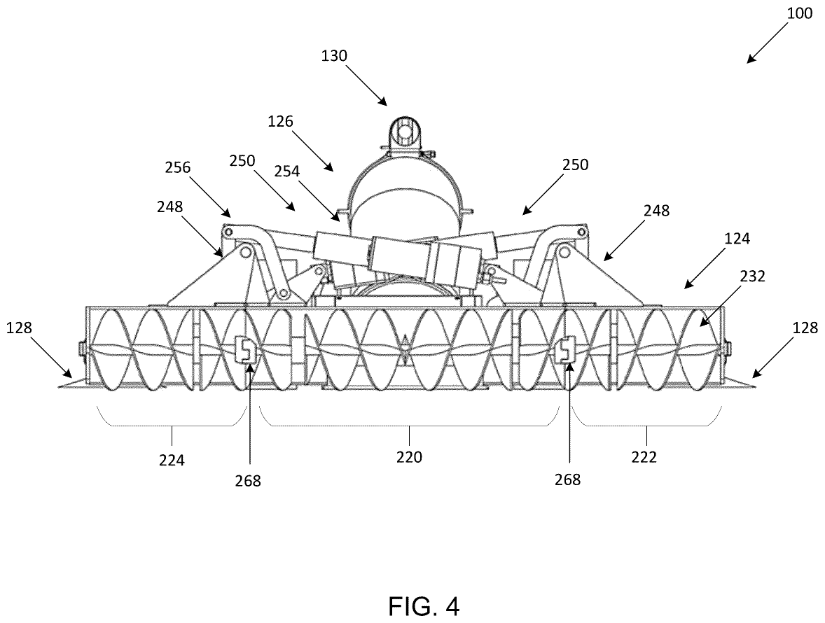

FIG. 5 is a top elevation view of a remote operated vehicle of a system for cleaning a grain bin, in accordance with one or more embodiments; the view showing a chassis, a foldable head assembly, brush assemblies, and an air passageway assembly, among other components.

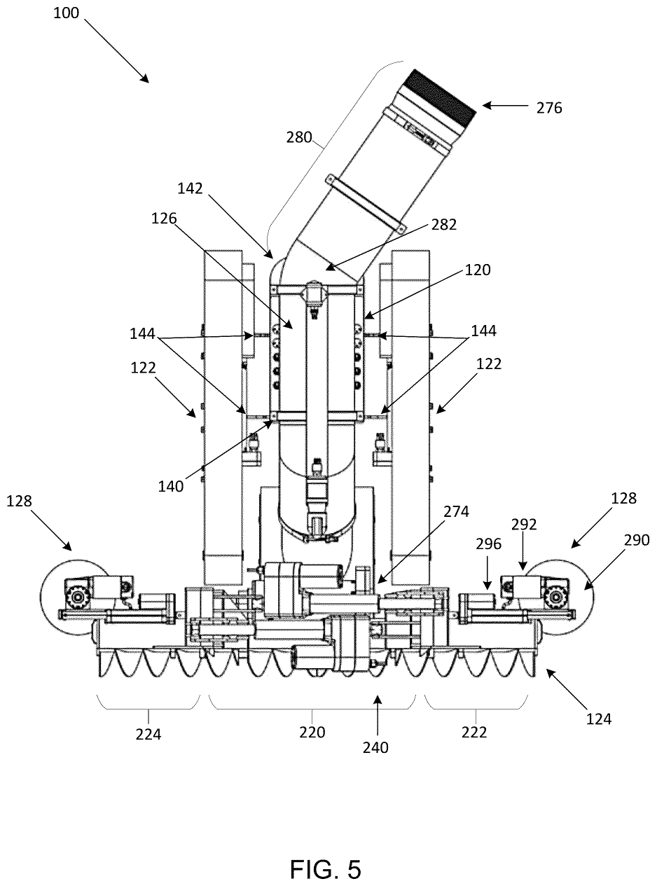

FIG. 6 is a top elevation view of a remote operated vehicle of a system for cleaning a grain bin, in accordance with one or more embodiments; the view showing a chassis, a foldable head assembly, brush assemblies, and an air passageway assembly, among other components.

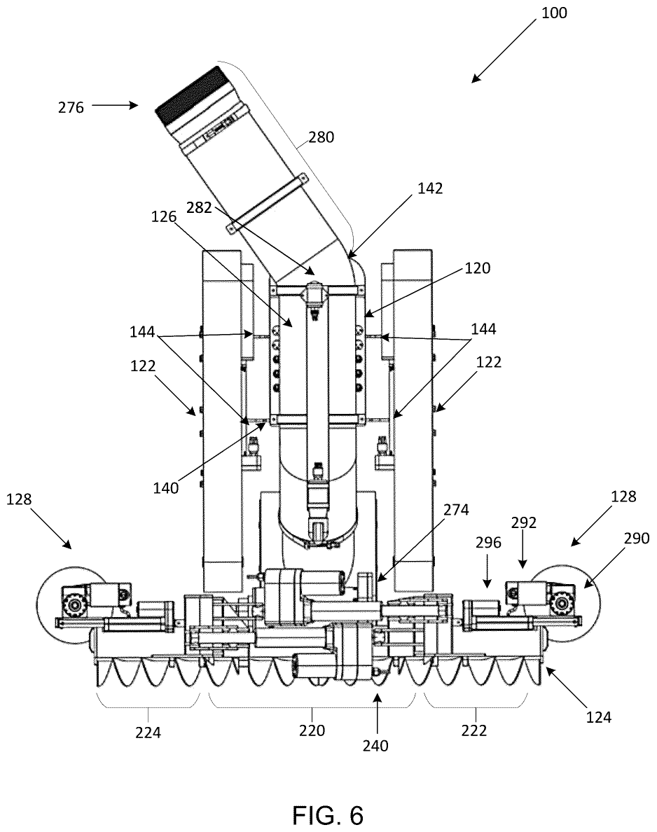

FIG. 7 is a front elevation view of a remote operated vehicle of a system for cleaning a grain bin, in accordance with one or more embodiments; the view showing a foldable head assembly in a folded position, among other components.

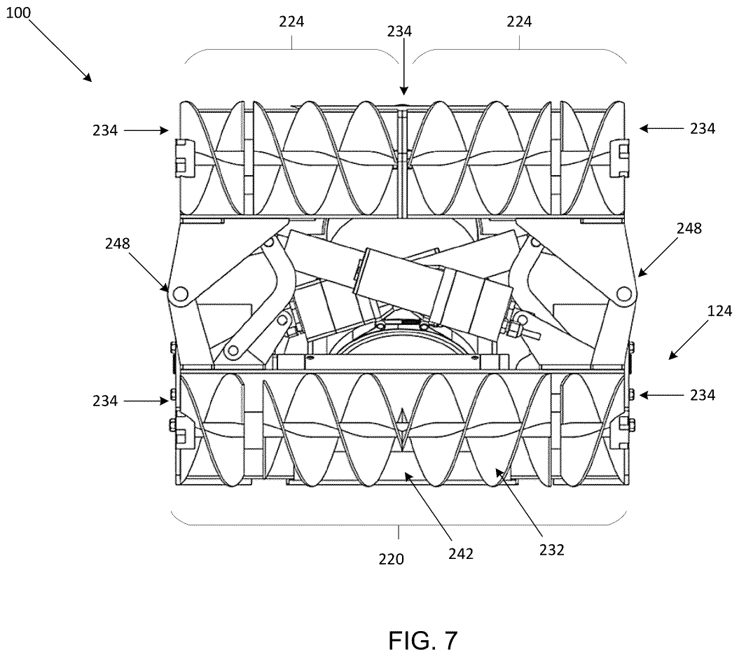

FIG. 8 is a side elevation view of a remote operated vehicle of a system for cleaning a grain bin, in accordance with one or more embodiments; the view showing a foldable head assembly in a folded position, among other components.

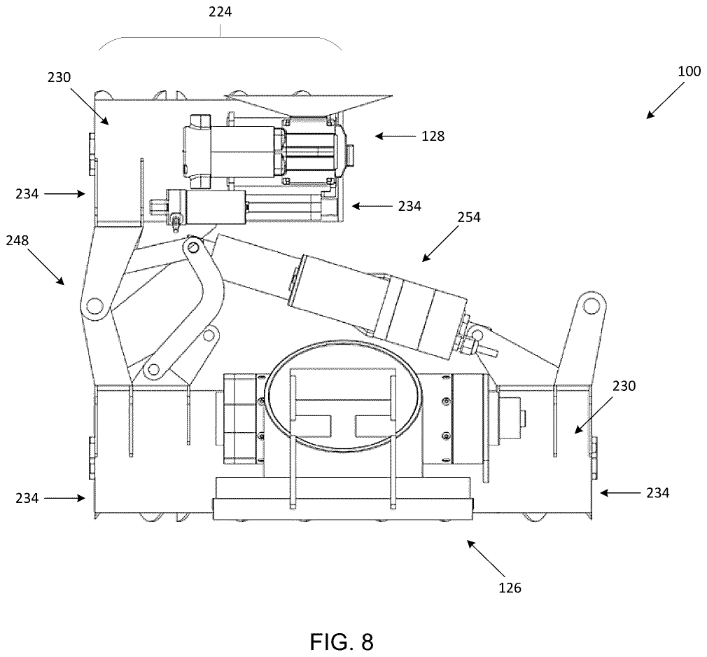

FIG. 9 is a perspective view of a remote operated vehicle of a system for cleaning a grain bin, in accordance with one or more embodiments; the view showing a chassis, drive assemblies, a foldable head assembly, brush assemblies, and an air passageway assembly, among other components.

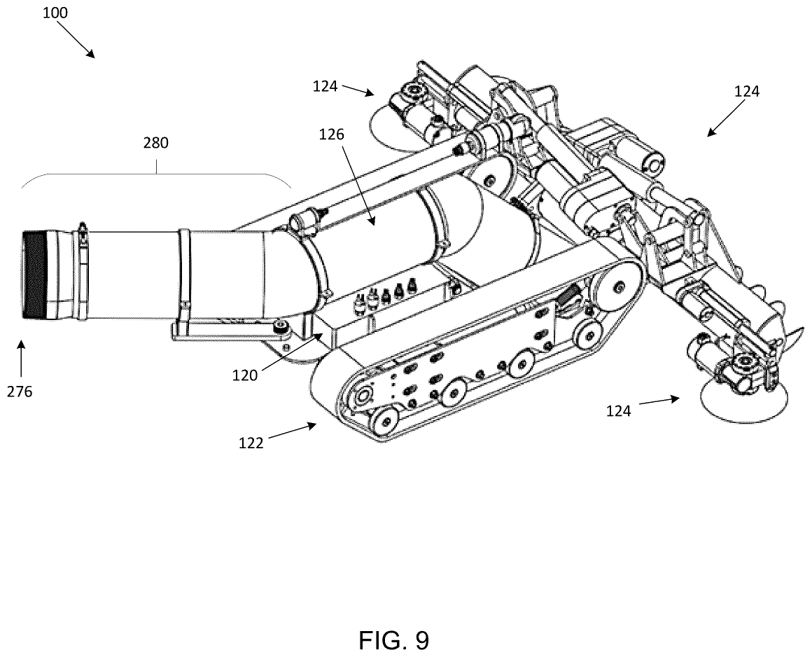

FIG. 10 is a perspective view of a remote operated vehicle of a system for cleaning a grain bin, in accordance with one or more embodiments; the view showing a chassis, drive assemblies, a foldable head assembly, brush assemblies, and an air passageway assembly, among other components.

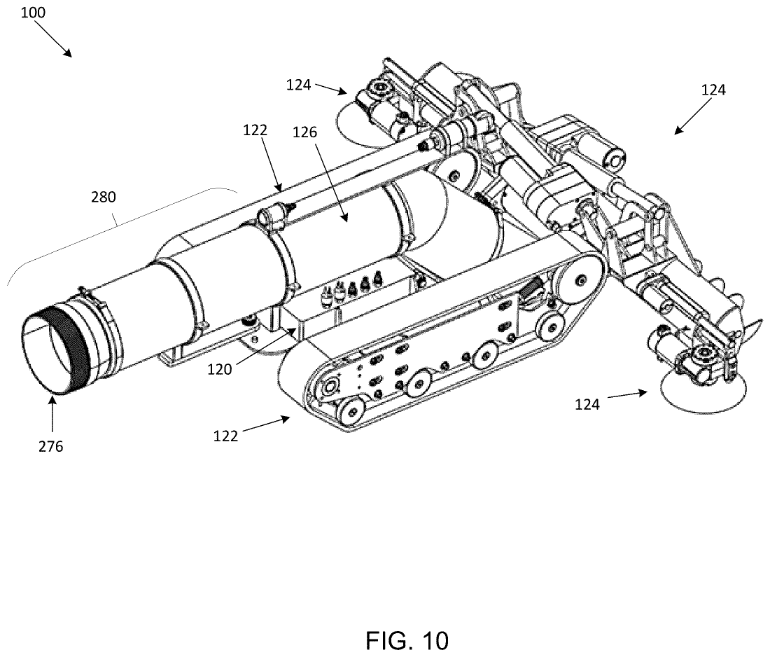

FIG. 11 is a perspective view of a remote operated vehicle of a system for cleaning a grain bin, in accordance with one or more embodiments; the view showing a chassis, drive assemblies, a foldable head assembly, brush assemblies, and an air passageway assembly, among other components.

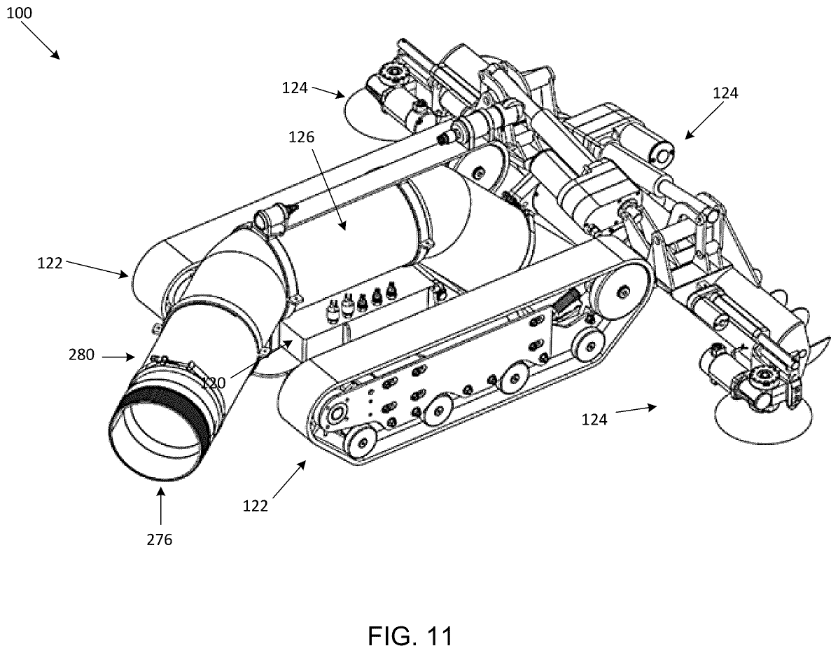

FIG. 12 is a side cutaway view of a remote operated vehicle of a system for cleaning a grain bin, in accordance with one or more embodiments; the view showing a chassis, a drive assembly, a foldable head assembly, brush assemblies, and an air passageway assembly, among other components.

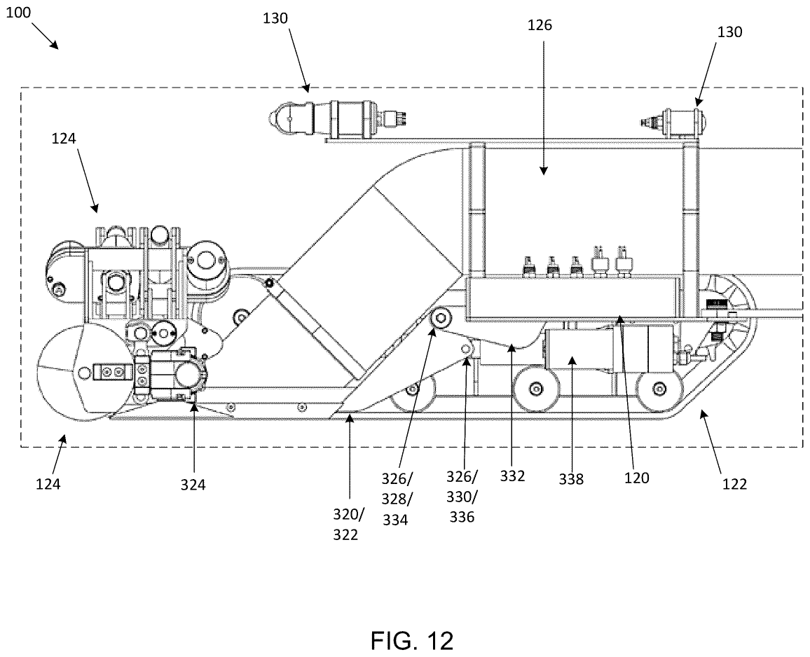

FIG. 13 is a side cutaway view of a remote operated vehicle of a system for cleaning a grain bin, in accordance with one or more embodiments; the view showing a chassis, a drive assembly, a foldable head assembly, brush assemblies, and an air passageway assembly, among other components.

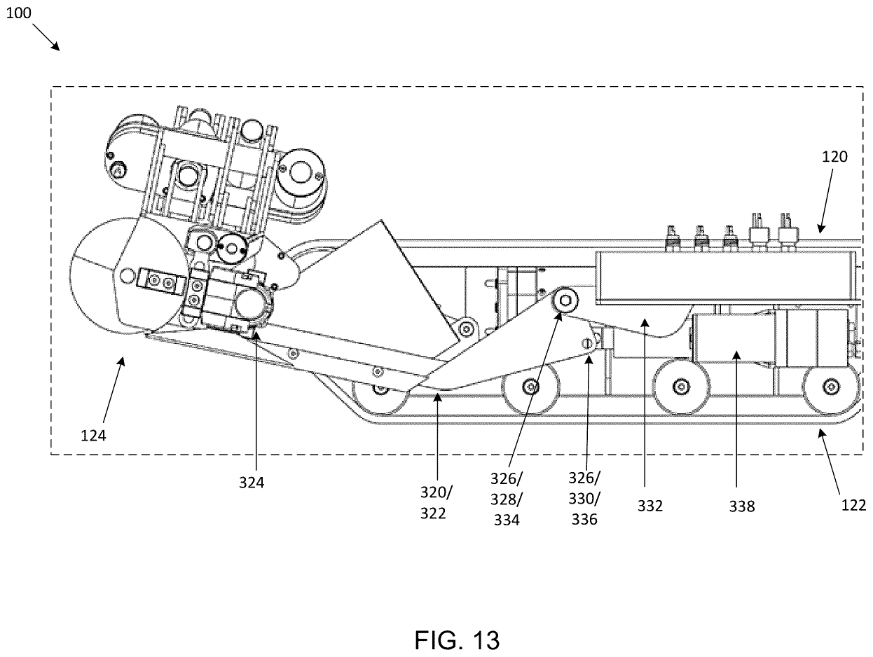

FIG. 14 is a side view of a remote operated vehicle of a system for cleaning a grain bin, in accordance with one or more embodiments; the view showing a chassis, drive assemblies, a foldable head assembly, brush assemblies, sensors, and an air passageway assembly, among other components.

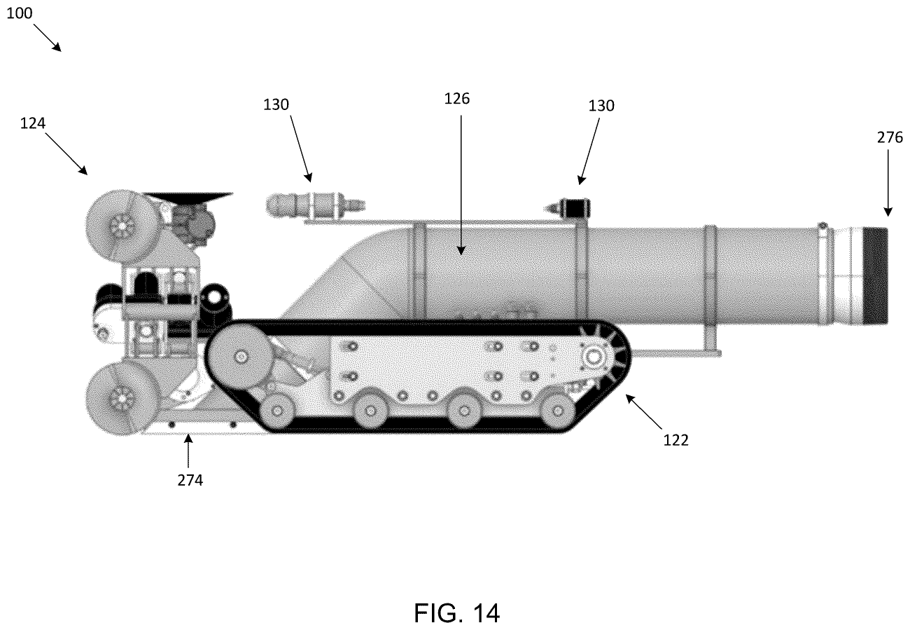

FIG. 15 is a side view of a remote operated vehicle of a system for cleaning a grain bin, in accordance with one or more embodiments; the view showing a chassis, drive assemblies, a foldable head assembly, brush assemblies, sensors, and an air passageway assembly, among other components.

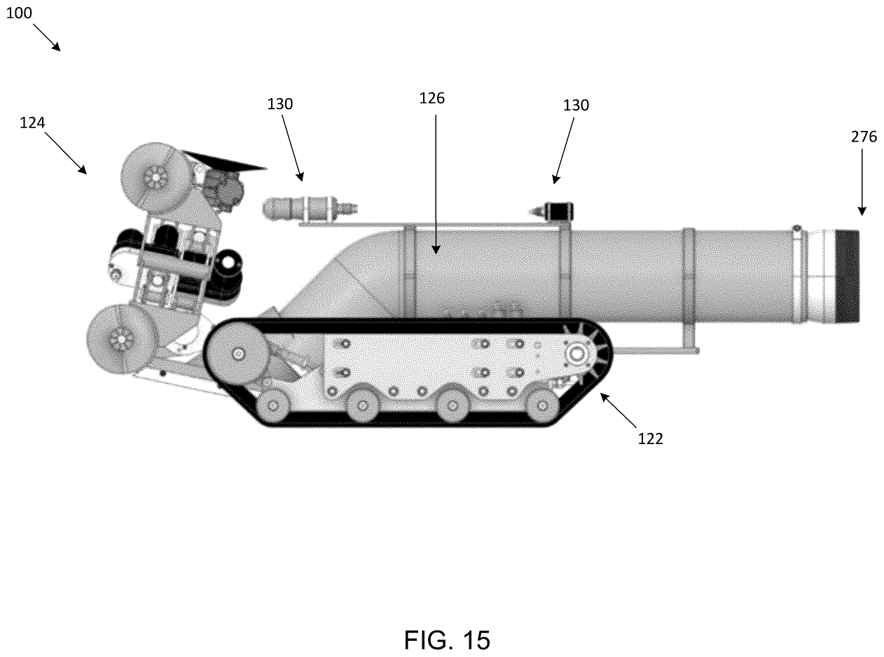

FIG. 16 is a perspective view of a foldable head assembly of a remote operated vehicle of a system for cleaning a grain bin, in accordance with one or more embodiments; the view showing the foldable head assembly in a folded position and an air passageway assembly, among other components.

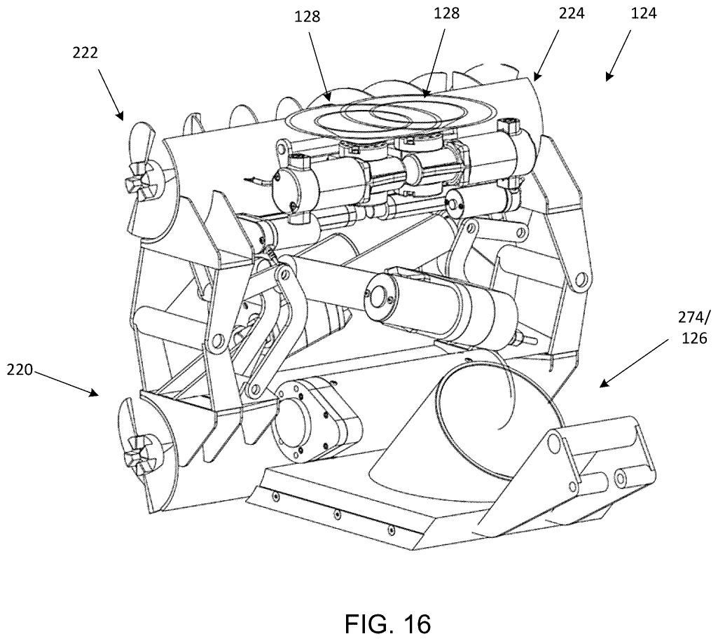

FIG. 17 is a perspective view of an end of a foldable head assembly of a remote operated vehicle of a system for cleaning a grain bin, in accordance with one or more embodiments; the view showing the foldable head assembly having a grain conveyor, axle mount arms, and interconnects, among other components.

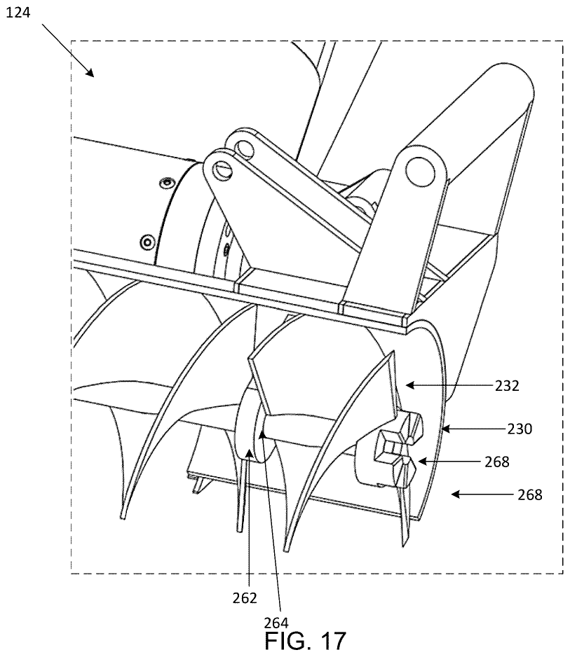

FIG. 18 is a perspective view of the center of a foldable head assembly of a remote operated vehicle of a system for cleaning a grain bin, in accordance with one or more embodiments; the view showing the foldable head assembly having a grain conveyor, axle mount arms, and interconnects, among other components.

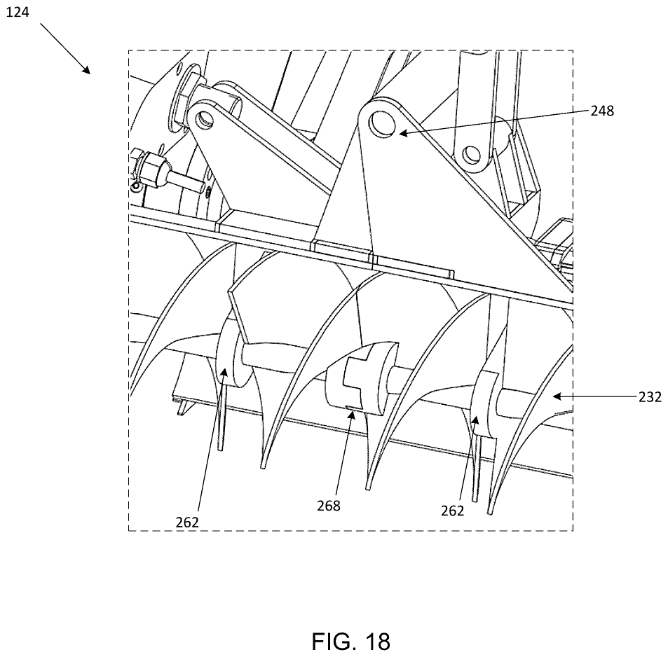

FIG. 19 is a perspective view of a brush assembly of a remote operated vehicle of a system for cleaning a grain bin, in accordance with one or more embodiments; the view showing the brush assembly in a retracted position having a brush, a motor, and extendable mount arms, among other components.

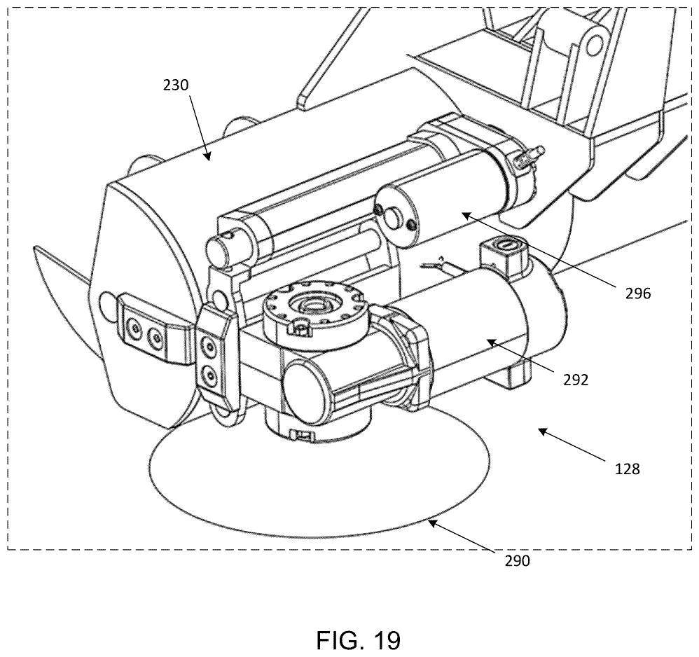

FIG. 20 is a perspective view of a brush assembly of a remote operated vehicle of a system for cleaning a grain bin, in accordance with one or more embodiments; the view showing the brush assembly in an extended position having a brush, a motor, and extendable mount arms, among other components.

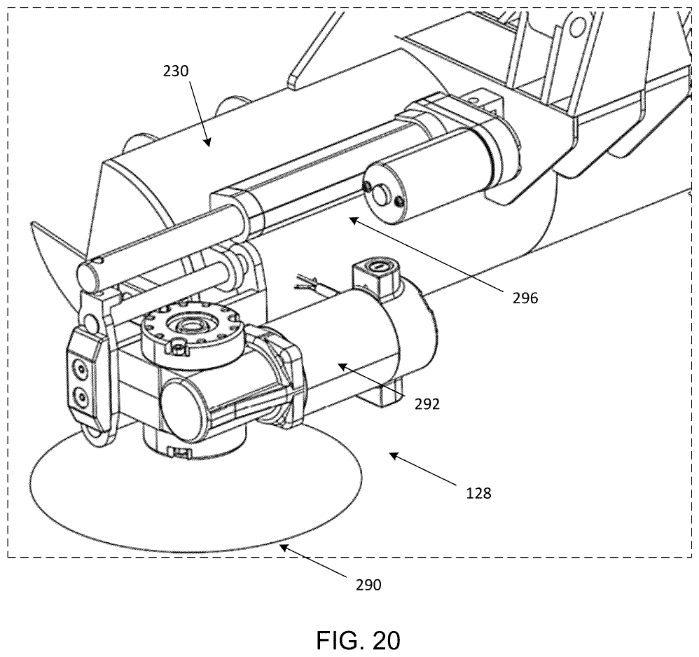

FIG. 21 is a front elevation view of a foldable head assembly and a brush assembly of a remote operated vehicle of a system for cleaning a grain bin, in accordance with one or more embodiments; the view showing the brush assembly in a retracted position and the foldable head assembly having a grain conveyor, among other components.

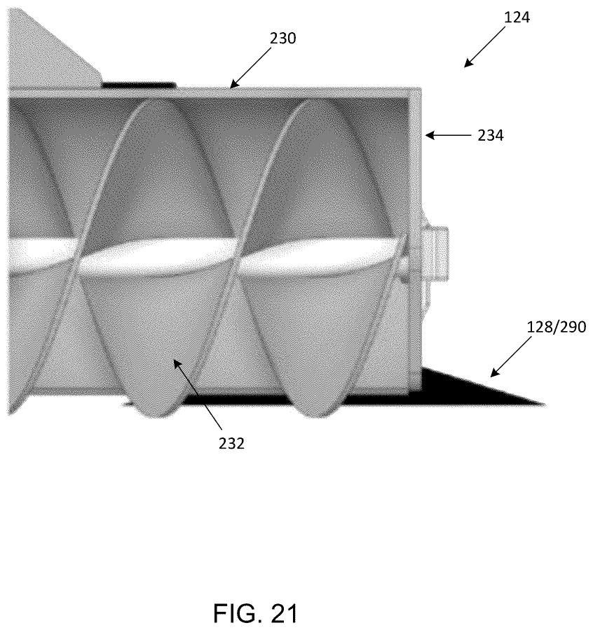

FIG. 22 is a front elevation view of a foldable head assembly and a brush assembly of a remote operated vehicle of a system for cleaning a grain bin, in accordance with one or more embodiments; the view showing the brush assembly in an extended position and the foldable head assembly having a grain conveyor, among other components.

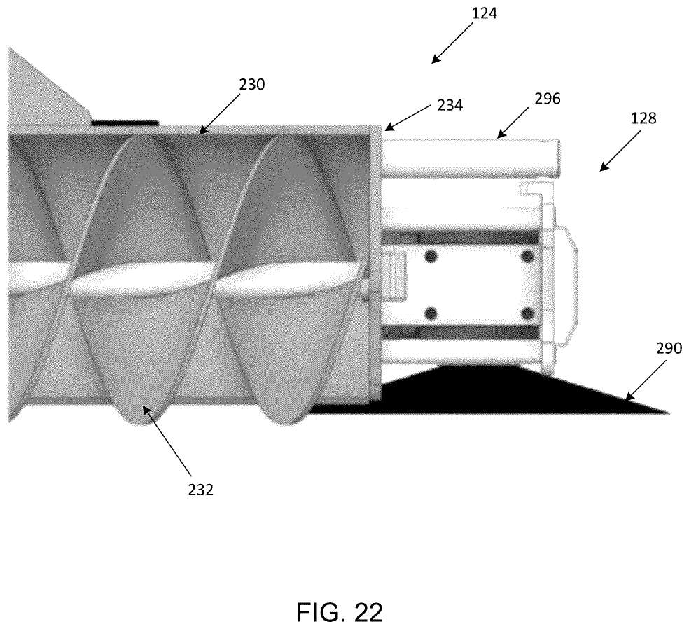

FIG. 23 is a rear cutaway view of a foldable head assembly and a brush assembly of a remote operated vehicle of a system for cleaning a grain bin, in accordance with one or more embodiments; the view showing the foldable head assembly having a center section, a foldable right section, an elongated body, and hydraulic cylinders, among other components.

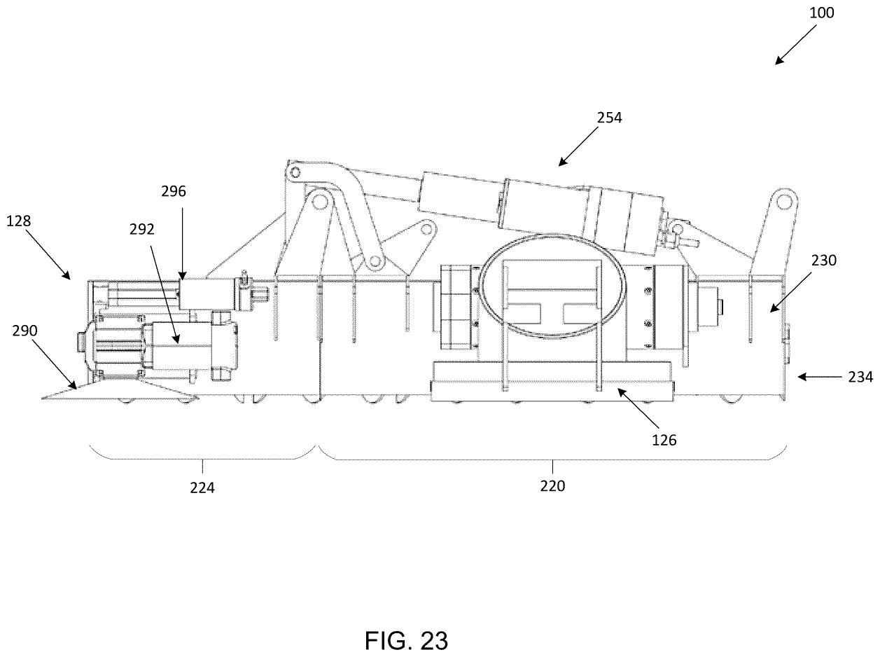

FIG. 24 is a rear perspective view of a foldable head assembly and brush assemblies of a remote operated vehicle of a system for cleaning a grain bin, in accordance with one or more embodiments; the view showing the foldable head assembly connected to an air passageway assembly, among other components.

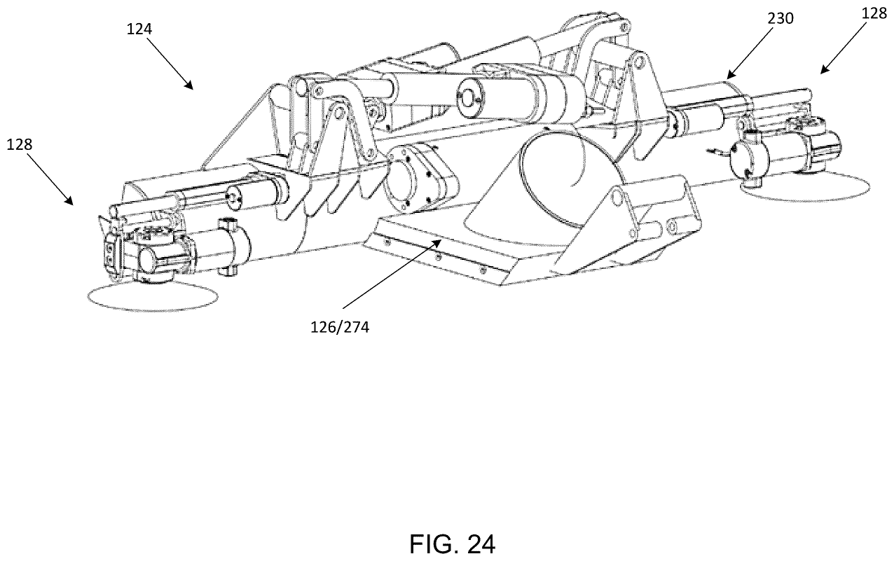

FIG. 25 is a side perspective view of a foldable head assembly and a brush assembly of a remote operated vehicle of a system for cleaning a grain bin, in accordance with one or more embodiments; the view showing the brush assembly having a brush, a motor, and extendable mount arms, among other components.

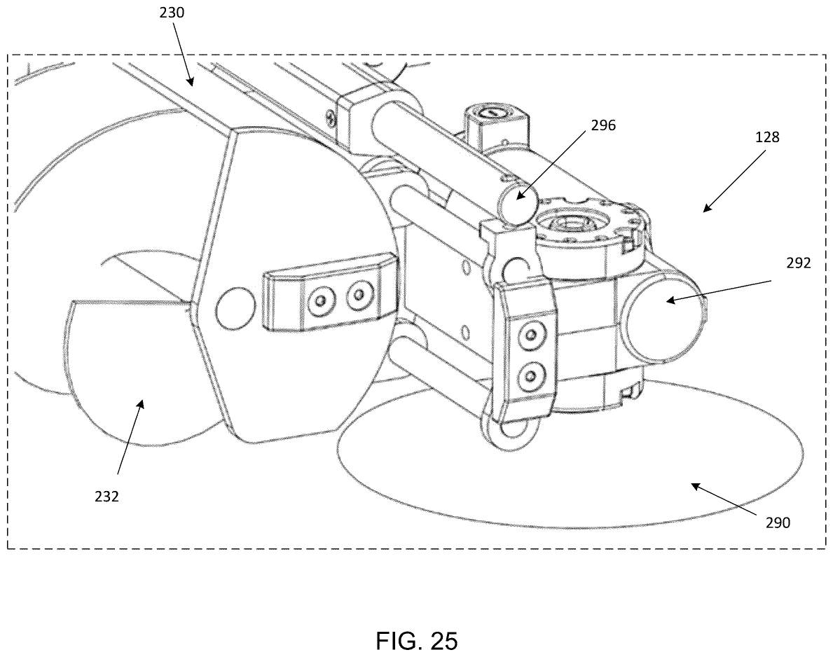

FIG. 26 is a perspective view of a forward end of an air passageway assembly of a remote operated vehicle of a system for cleaning a grain bin, in accordance with one or more embodiments; the view showing the air passageway assembly connected to the foldable head assembly, among other components.

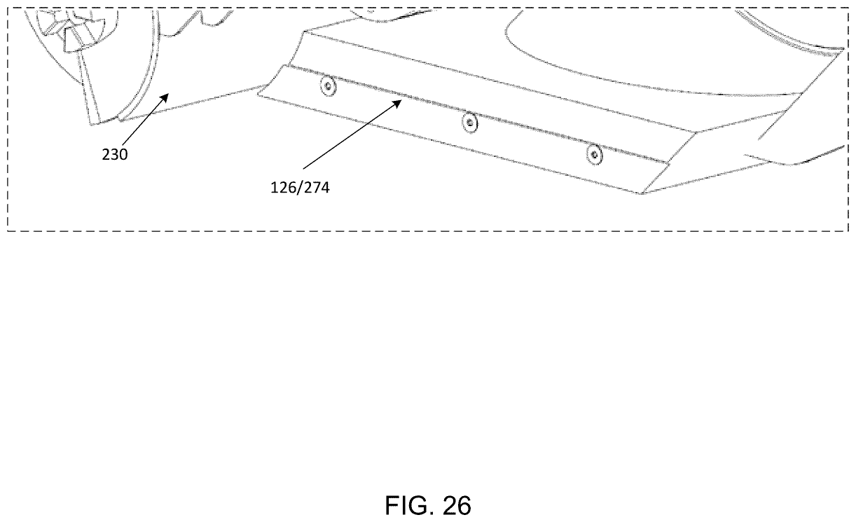

FIG. 27 is a perspective view of a sensor of a remote operated vehicle of a system for cleaning a grain bin, in accordance with one or more embodiments; the view showing the sensor connected to the air passageway assembly, among other components.

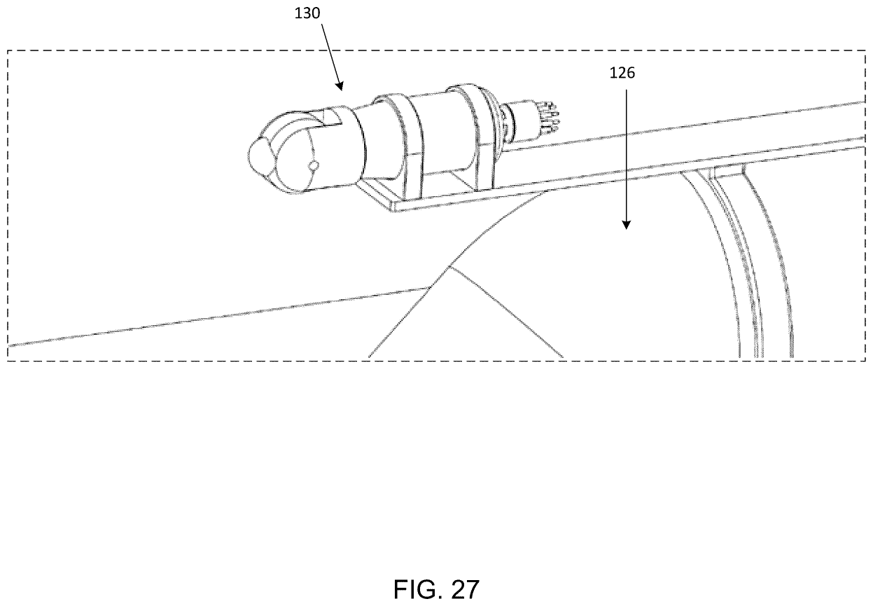

FIG. 28 is a perspective view of a central portion of a remote operated vehicle of a system for cleaning a grain bin, in accordance with one or more embodiments; the view showing the sensor connected to the air passageway assembly, among other components.

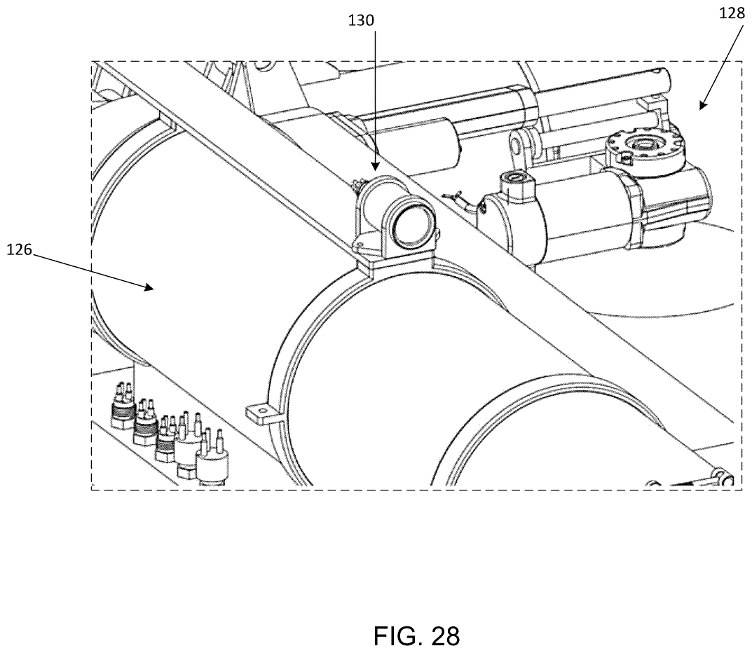

FIG. 29 is an exploded view of a drive assembly of a remote operated vehicle of a system for cleaning a grain bin, in accordance with one or more embodiments; the view showing the drive assembly having tracks, sprockets, rollers, motor assemblies, and a mounting assembly, among other components.

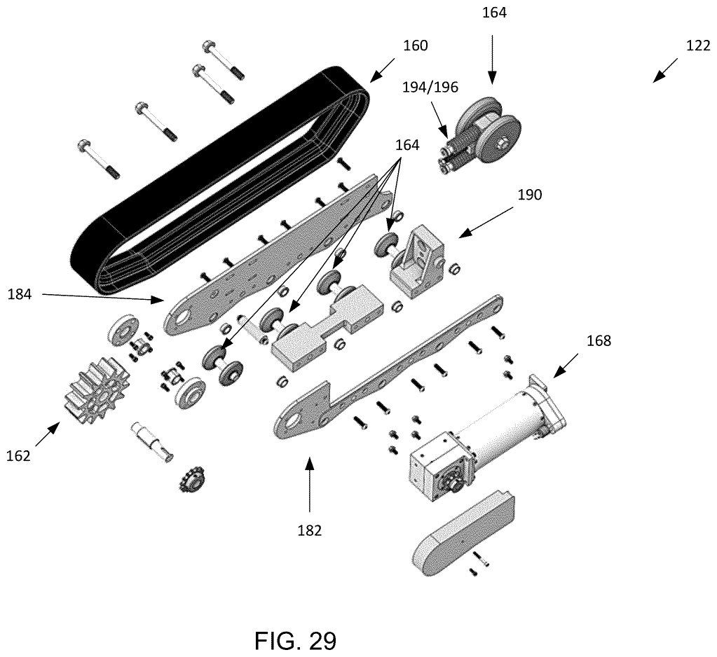

FIG. 30 is an exploded view of a drive assembly of a remote operated vehicle of a system for cleaning a grain bin, in accordance with one or more embodiments; the view showing the drive assembly having tracks, sprockets, rollers, motor assemblies, and a mounting assembly, among other components.

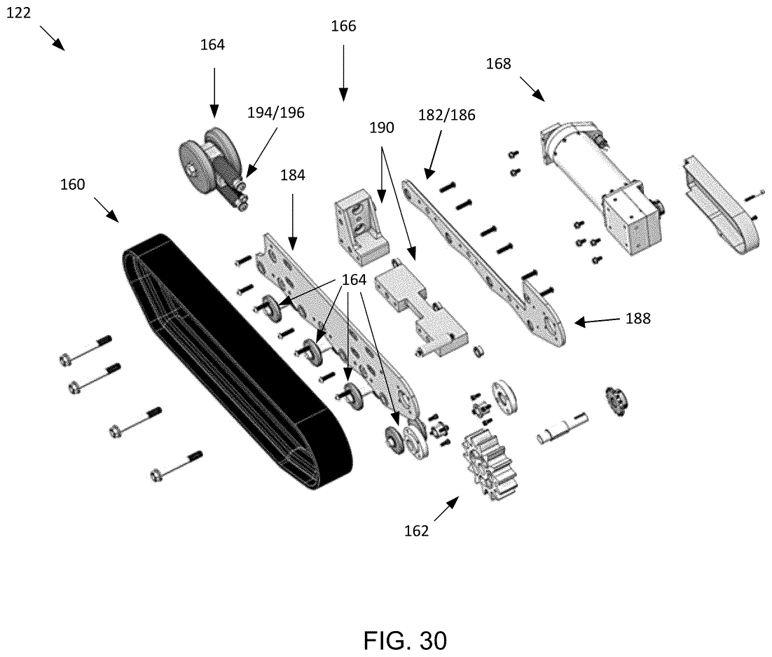

FIG. 31 is a perspective view of a motor assembly of a drive assembly of a remote operated vehicle of a system for cleaning a grain bin, in accordance with one or more embodiments; the view showing the motor assembly having a motor and a gear assembly, among other components.

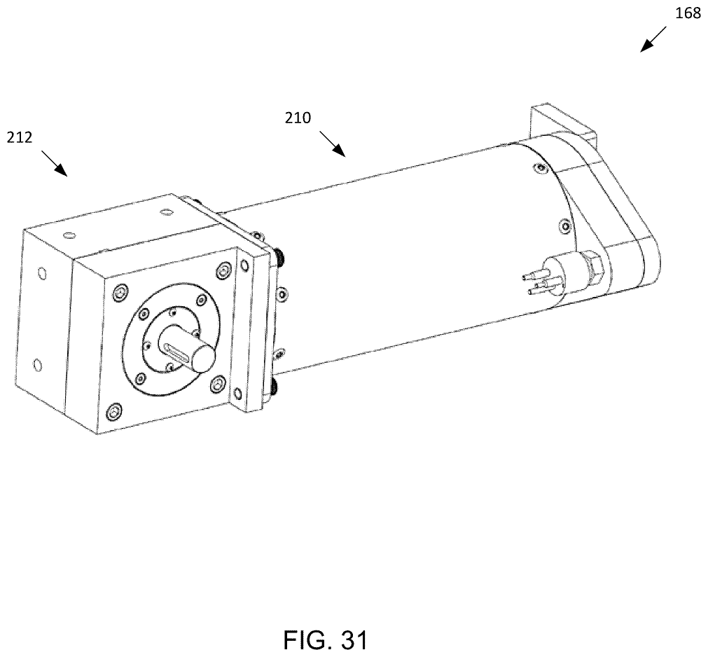

FIG. 32 is an exploded view of a motor assembly of a drive assembly of a remote operated vehicle of a system for cleaning a grain bin, in accordance with one or more embodiments; the view showing the motor assembly having a motor and a gear assembly, among other components.

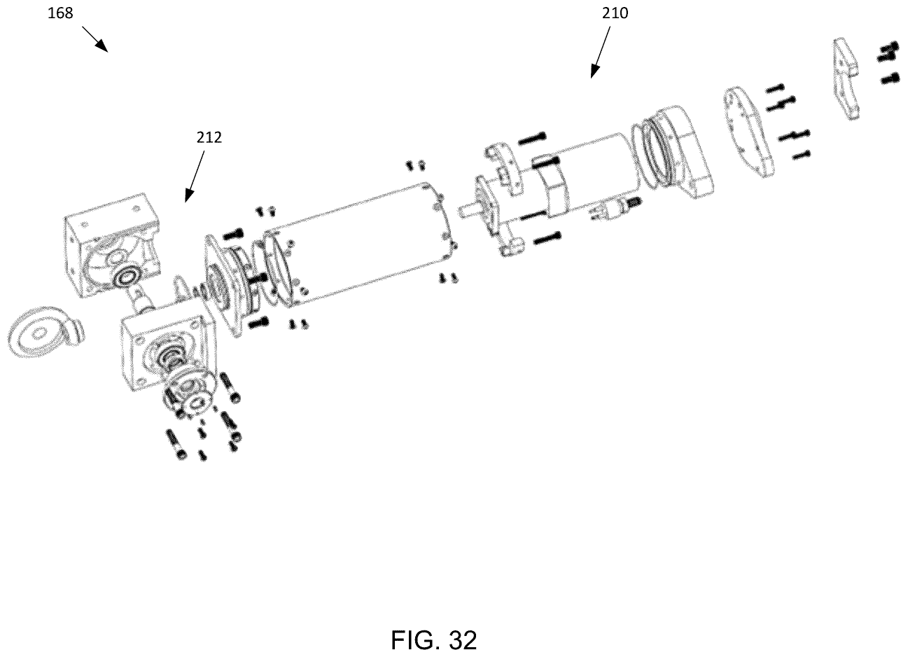

FIG. 33 is an exploded view of an end of a motor assembly of a drive assembly of a remote operated vehicle of a system for cleaning a grain bin, in accordance with one or more embodiments.

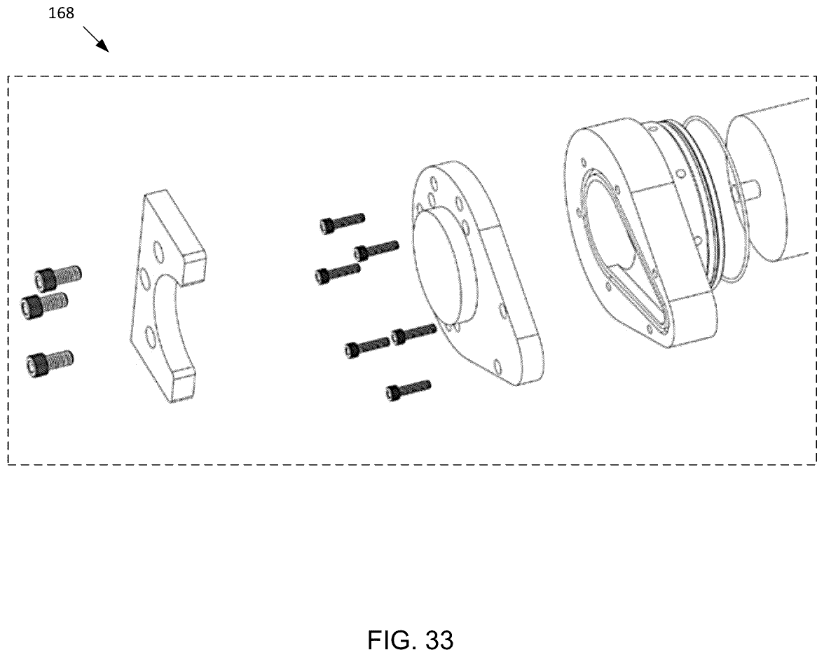

FIG. 34 is an exploded view of a portion of a motor assembly of a drive assembly of a remote operated vehicle of a system for cleaning a grain bin, in accordance with one or more embodiments.

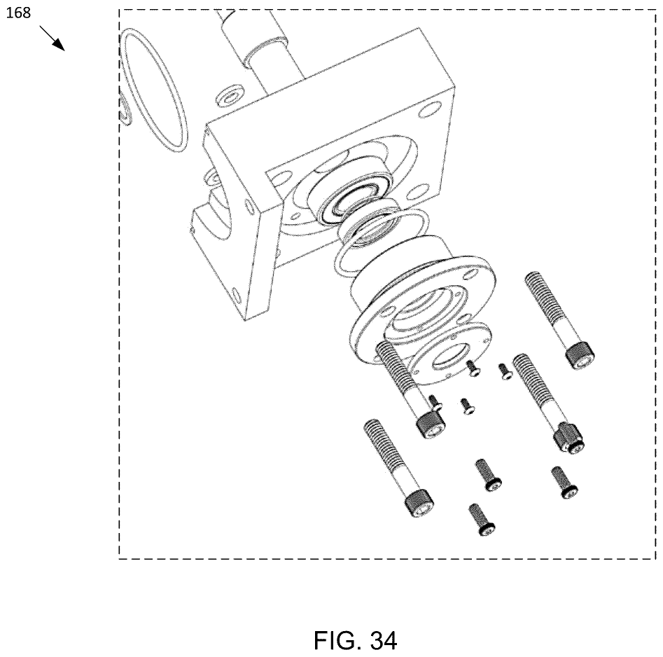

FIG. 35 is a cross-section view of a motor assembly of a drive assembly of a remote operated vehicle of a system for cleaning a grain bin, in accordance with one or more embodiments; the view showing the motor assembly having a motor and a gear assembly, among other components.

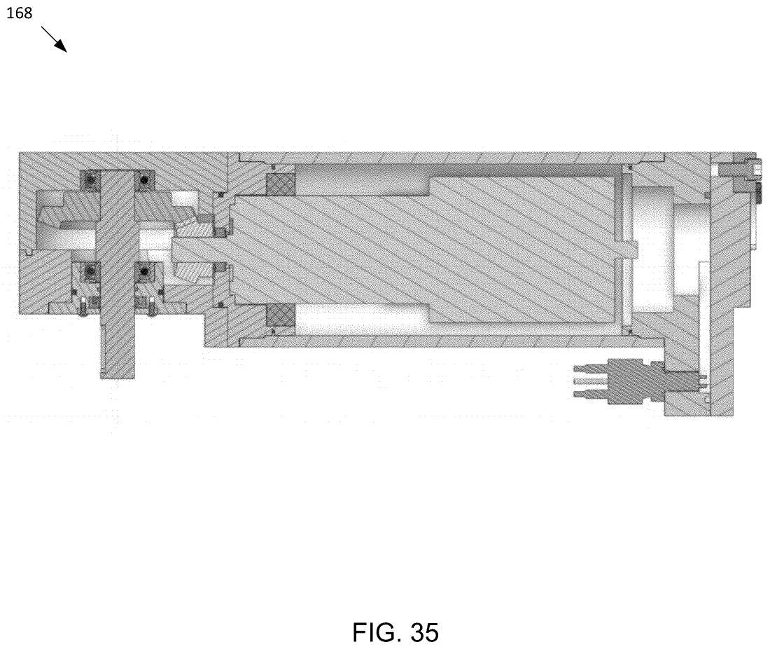

FIG. 36 is a plan view of a system for cleaning a grain bin, in accordance with one or more embodiments; the view showing the system having a grain vacuum, a control system, a motorized hose coil, and a remote operated vehicle, among other components.

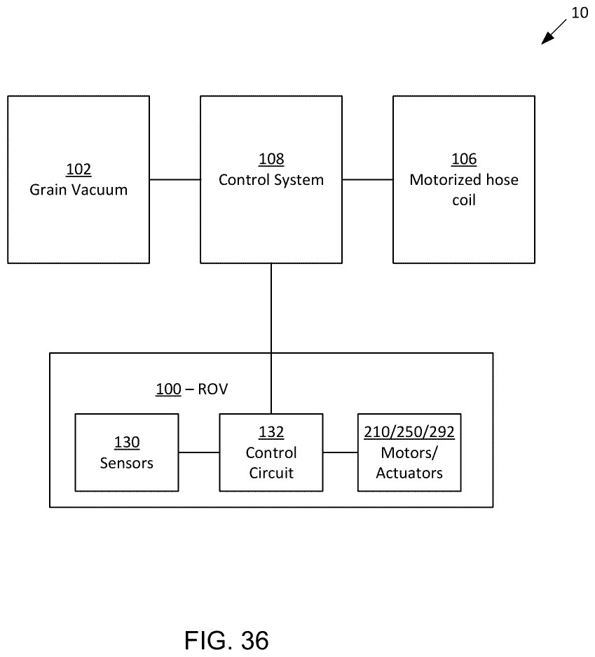

FIG. 37 is a plan view of a control system and control circuit of a remote operated vehicle of a system for cleaning a grain bin, in accordance with one or more embodiments; the view showing the control system having a processing system connected to sensors and user interface, among other components.

FIG. 38 shows a flow chart of an example process for cleaning a grain bin, in accordance with one or more embodiments.

### DETAILED DESCRIPTION OF THE DISCLOSURE

In the following detailed description of the embodiments, reference is made to the accompanying drawings which form a part hereof, and in which is shown by way of illustration specific embodiments in which the disclosure may be practiced. The embodiments of the present disclosure described below are not intended to be exhaustive or to limit the disclosure to the precise forms in the following detailed description. Rather, the embodiments are chosen and described so that others skilled in the art may appreciate and understand the principles and practices of the present disclosure. It will be understood by those skilled in the art that various changes in form and details may be made without departing from the principles and scope of the invention. It is intended to cover various modifications and similar arrangements and procedures, and the scope of the appended claims therefore should be accorded the broadest interpretation so as to encompass all such modifications and similar arrangements and procedures. For instance, although aspects and features may be illustrated in and/or described with reference to certain figures and/or embodiments, it will be appreciated that features from one figure and/or embodiment may be combined with features of another figure and/or embodiment even though the combination is not explicitly shown and/or explicitly described as a combination. In the depicted embodiments, like reference numbers refer to like elements throughout the various drawings.

It should be understood that any advantages and/or improvements discussed herein may not be provided by various disclosed embodiments, and/or implementations thereof. The contemplated embodiments are not so limited and should not be interpreted as being restricted to embodiments that provide such advantages and/or improvements. Similarly, it should be understood that various embodiments may not address all or any objects of the disclosure and/or objects of the invention that may be described herein. The contemplated embodiments are not so limited and should not be interpreted as being restricted to embodiments that address such objects of the disclosure and/or invention. Furthermore, although some disclosed embodiments may be described relative to specific materials, embodiments are not limited to the specific materials and/or apparatuses but only to their specific characteristics and capabilities and other materials and apparatuses can be substituted as is well understood by those skilled in the art in view of the present disclosure. Moreover, although some disclosed embodiments may be described in the context of farming, the embodiments are not so limited. It is appreciated that the embodiments may be adapted for use in other applications which may be improved by the disclosed structures, arrangements and/or methods.

It is to be understood that the terms such as “left, right, top, bottom, front, back, side, height, length, width, upper, lower, interior, exterior, inner, outer, and the like as may be used herein, merely describe points of reference and do not limit the present invention to any particular orientation and/or configuration.

As used herein, “and/or” includes all combinations of one or more of the associated listed items, such that “A and/or B” includes “A but not B,” “B but not A,” and “A as well as B,” unless it is clearly indicated that only a single item, subgroup of items, or all items are present. The use of “etc.” is defined as “et cetera” and indicates the inclusion of all other elements belonging to the same group of the preceding items, in any “and/or” combination(s).

As used herein, the singular forms “a,” “an,” and “the” are intended to include both the singular and plural forms, unless the language explicitly indicates otherwise. Indefinite articles like “a” and “an” introduce or refer to any modified term, both previously-introduced and not, while definite articles like “the” refer to a same previously-introduced term; as such, it is understood that “a” or “an” modify items that are permitted to be previously-introduced or new, while definite articles modify an item that is the same as immediately previously presented. It will be further understood that the terms “comprises,” “comprising,” “includes,” and/or “including,” when used herein, specify the presence of stated features, characteristics, steps, operations, elements, and/or components, but do not themselves preclude the presence or addition of one or more other features, characteristics, steps, operations, elements, components, and/or groups thereof, unless expressly indicated otherwise. For example, if an embodiment of a system is described as comprising an article, it is understood the system is not limited to a single instance of the article unless expressly indicated otherwise, even if elsewhere another embodiment of the system is described as comprising a plurality of articles.

It will be understood that when an element is referred to as being “connected,” “coupled,” “mated,” “attached,” “fixed,” etc. to another element, it can be directly connected to the other element, or intervening elements may be present. In contrast, when an element is referred to as being “directly connected,” “directly coupled,” etc. to another element, there are no intervening elements present. Other words used to describe the relationship between elements should be interpreted in a like fashion (e.g., “between” versus “directly between,” “adjacent” versus “directly adjacent,” etc.). Similarly, a term such as “communicatively connected” includes all variations of information exchange and routing between two electronic devices, including intermediary devices, networks, etc., connected wirelessly or not.

It will be understood that, although the ordinal terms “first,” “second,” etc. may be used herein to describe various elements, these elements should not be limited to any order by these terms. These terms are used only to distinguish one element from another; where there are “second” or higher ordinals, there merely must be that many number of elements, without necessarily any difference or other relationship. For example, a first element could be termed a second element, and, similarly, a second element could be termed a first element, without departing from the scope of example embodiments and/or methods.

Similarly, the structures and operations discussed below may occur out of the order described and/or noted in the figures. For example, two operations and/or figures shown in succession may in fact be executed concurrently or may sometimes be executed in the reverse order, depending upon the functionality/acts involved. Similarly, individual operations within example methods described below may be executed repetitively, individually, and/or sequentially, to provide looping and/or other series of operations aside from single operations described below. It should be presumed that any embodiment and/or method having features and functionality described below, in any workable combination, falls within the scope of example embodiments.

As used herein, various disclosed embodiments may be primarily described in the context of grain bins. However, the embodiments are not so limited. It is appreciated that the embodiments may be adapted for use in other applications which may be improved by the disclosed structures, arrangements and/or methods. The system is merely shown and described as being used in the context of grain bins for ease of description and as one of countless example applications.

Turning now to the figures, a remote operated vehicle is presented for removal of grain from and cleaning of grain storage devices, such as a grain bin 12, is shown as one example.

### System 10

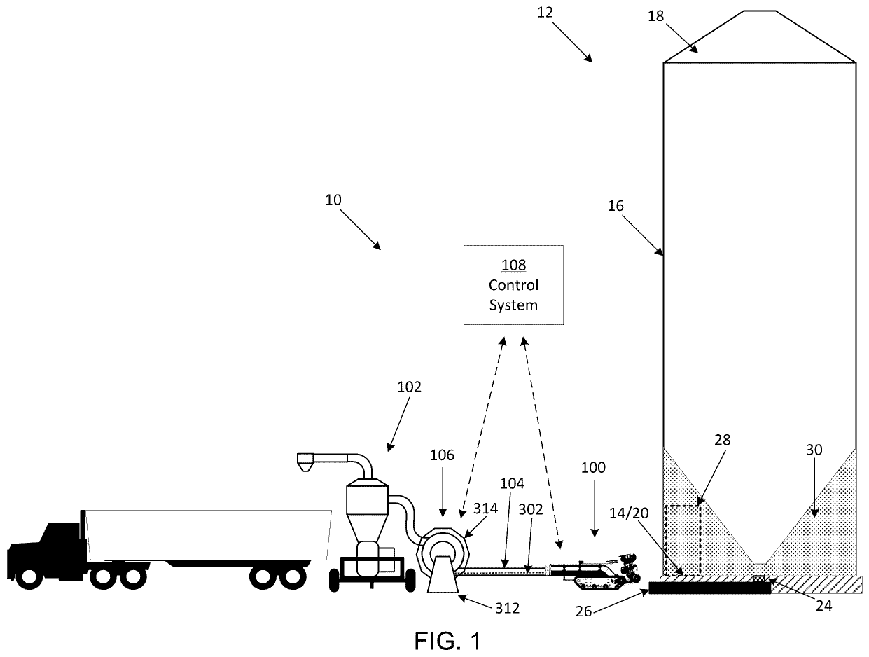

With reference to the figures, system 10 for cleaning of grain bins (or simply system 10 is presented). The system 10 is used in association with a grain bin 12, as seen in FIGS. 1 & 2 for example, generally having a foundation 14, a sidewall 16, a peaked roof 18, floor 20 on or above the foundation 14, a sump(s) 24, and a grain conveyor 26.

In one or more arrangements, the system 10 includes a remote operated vehicle 100, a grain vacuum 102, a hose 104 for connecting the remote operated vehicle 100 with the grain vacuum 102, an actuated hose coil 106, and a control system 108, among other components as is described herein and shown in the figures.

### Grain Bin 12

In the arrangement shown, system 10 is used in association with a grain bin 12 to facilitate removal of grain 30 when cleaning a grain bin 12. Grain bin 12 may be formed of any suitable size, shape, and design and is configured to hold a bulk amount of flowable material such as grain 30, granular materials, and/or other like materials. In the arrangement shown, as one example, grain bin 12 is a large, generally cylindrical structure that sits upon a foundation 14. Foundation 14 may be formed of any suitable size, shape, and design and is configured to provide support to grain bin 12. In the arrangement shown, as one example, foundation 14 is a circular or cylindrical concrete slab, however any other form of a foundation 14 is hereby contemplated for use. In some various different arrangements, a top surface of foundation 14 may operate as a floor 20 of the grain bin 12 (e.g., a non-elevated floor) or may support a floor 20 constructed thereon (e.g., an elevated floor). In the arrangement shown, as one example, foundation 14 also provides support for the lower end of sidewall 16.

In the arrangement shown, as one example, grain bin 12 has a sidewall 16. Sidewall 16 may be formed of any suitable size, shape, and design and is configured to enclose the contents of grain bin 12 and enclose the hollow interior of grain bin 12. In the arrangement shown, as one example, sidewall 16 is cylindrical in nature and is formed of a plurality of sheets of corrugated material that are connected to one another in end-to-end relation to form rings. These rings are stacked on top of one another to form the desired height of sidewall 16 of grain bin 12. However, any other form or configuration of a sidewall 16 is hereby contemplated for use. In the arrangement shown, as one example, the upper end of sidewall 16 provides support for peaked roof 18.

In the arrangement shown, as one example, grain bin 12 has a peaked roof 18. Peaked roof 18 may be formed of any suitable size, shape, and design and is configured to enclose the upper end of grain bin 12 and enclose the hollow interior of grain bin 12. In the arrangement shown, as one example, peaked roof 18 is formed of a plurality of panels that extend from the peak of the roof 18 downward and outward to the upper edge of sidewall 16. However, any other form or configuration of a roof 18 is hereby contemplated for use.

### Sump 24:

In the arrangement shown, as one example, grain bin 12 includes one or more sumps 24 formed in floor 20 of grain bin 12. Sumps 24 are formed of any suitable size, shape, and design and are configured to selectively allow grain 30 to pass through the floor 20 and into a grain conveyor 26 that is positioned below floor 20, thereby allowing grain 30 out of grain bin 12. In an example arrangement shown, as one example, grain bin 12 has sumps 24 in floor 20, which are formed of an opening that is covered by a gate that selectively opens and closes by operation of a control mechanism (not shown) so as to facilitate grain 30 to enter grain conveyor 26 positioned below sump 24.

In one or more arrangements, grain bin 12 includes a first sump 24 positioned in a center of the grain bin 12 and a second sump 24 positioned by the door. When grain 30 is to be removed, the first sump 24 is opened and grain conveyor 26 is operated to remove a majority of the grain 30. In this process, an inverse cone of grain 30 is formed and remains in the grain bin 12. At this point, the second sump 24 by the door (and/or additional sumps) are opened to facilitate removal of the inverse cone portion of grain 30 that would prevent opening of a door 28 of the grain bin 12.

### Grain Conveyor 26:

In the arrangement shown, as one example, system 10 includes a grain conveyor 26. Grain conveyor 26 is formed of any suitable size, shape, and design and is configured to move grain 30 out of grain bin 12, such as through a sump 24 or another opening in the elevated floor 20. In some various arrangements, grain conveyor 26 may be implemented using various grain movement devices including but not limited to, for example, an auger, a conveyor belt, a drag chain, and/or any other form of a grain movement device.

In some elevated floor arrangements, grain conveyor 26 is positioned below sump(s) 24 between foundation 14 and elevated floor 20. In a non-elevated floor arrangement, grain conveyor 26 is positioned below sump(s) 24 in a channel formed within foundation and extending to an exterior of the grain bin 12. In an example elevated floor arrangement shown, as one example, grain conveyor 26 includes a cylindrical shaped housing forming a hollow interior extending from a center sump 24 to an output end. In this example arrangement, an auger or other grain movement device (e.g., a belt or drag chain) is positioned within the hollow interior. In one or more arrangements, auger includes a shaft with flighting configured to facilitate removal of grain 30 from grain conveyor 26 as the shaft is rotated. In an arrangement shown, as one example, grain conveyor 26 is powered by a motor 32 (not shown) operably connected to the shaft of the auger at the outward end of grain conveyor 26.

Motor 32 is formed of any suitable size, shape, and design and is configured to generate movement to drive grain conveyor 26. In some various arrangements, motor 32 may be implemented using various methods and/or means for generating movement including but not limited to, for example, an AC electric motor, a DC electric motor, pneumatic motor, hydraulic motor, combustion motor, and/or any other method or means for generating movement. When operated, motor 32 causes the rotation of auger, which facilitates the below-floor 20 transportation of grain 30 from grain bin 12, from sumps 24, through hollow interior of housing to output end of grain conveyor 26.

### Remote Operated Vehicle 100

Remote operated vehicle 100 is formed of any suitable size, shape, and design and is configured to be remotely piloted or automatically navigated in a grain bin 12 to facilitate removal of grain 30 (e.g., via suction provided by grain vacuum 102).

In one or more arrangements, as is shown, remote operated vehicle 100 includes

a main chassis 120, drive assemblies 122, a foldable head assembly 124, an air passageway assembly 126, brush assemblies 128, and/or a control circuit 132, among other components.

### Main Chassis 120:

Main chassis 120 is formed of any suitable size, shape, and design and is configured to provide a rigid structure for operably connecting various components of remote operated vehicle 100 together. In the arrangement shown, as one example, chassis 120 is a frame structure extending from a head end 140, where chassis 120 operably connects with foldable head assembly 124, to a tail end 142 and extending outward to opposing sides 144, where chassis operably connects with drive assemblies 122.

### Drive Assemblies 122:

In one or more arrangements, remote operated vehicle 100 includes one or more drive assemblies 122. Drive assemblies 122 may also be referred to as track assemblies 122. Drive assemblies 122 are formed of any suitable size, shape, and design and are configured to facilitate movement of remote operated vehicle 100.

In one or more arrangements shown, remote operated vehicle 100 has a pair of drive assemblies 122 which utilize tracks 160 to facilitate movement. However, the arrangements are not so limited. Rather, it is contemplated that in some various arrangements, remote operated vehicle 100 may utilize various different mechanisms to facilitate movement of the remote operated vehicle 100 when operated including but not limited to powered wheels, tracks, rails, legs, or any other mechanism to facilitate movement.

In the arrangement shown, as one example, drive assemblies 122 includes respective tracks 160, sprockets 162 and/or rollers 164, mounting assembly 166, and motor assemblies 168, among other components.

In this example arrangement, tracks 160 are positioned to rotate in an elongated loop extending around a set of sprockets 162 and/or rollers 164. Tracks 160 are formed of any suitable size, shape, and design and are configured to contact an upper surface of floor 20 in grain bin 12 to facilitate movement of remote operated vehicle 100 as tracks 160 are rotated. In the arrangement shown, as one example, each track 160 includes a plurality of interconnected chain links having track plates or shoes connected thereto.

While most of the components of system 10 are made of metal, in one or more arrangements, plates 176 (not shown) of tracks 160 or other various components of system 10 may be formed of a plastic or composite or non-metallic material, such as an ultra-high molecular weight polyethylene (UHMW) or other UHMW or similar material. In some embodiments, using a non-metallic material may provide a number of benefits including, for example, being easier or softer on the grain, being easier on the other components of the system, being more-durable than metal, being self-lubricating, being lighter than metal, being lower friction, being impact resistant, and/or eliminating metal on metal contact among many other benefits.

While some arrangements may be primarily shown or described with reference to link based tracks, the arrangements are not so limited. Rather, it is contemplated that in some arrangements, tracks 160 may be implemented by a molded track or belt configured to rotate on sprocket(s) 162 and/or roller(s) 164. For example, in some implementations, the molded track or belt may include elongated strips of flexible material having an exterior surface and an interior surface extending between opposing side edges and connected in a loop. Such molded track or belt may include a set of treads formed on exterior surface that are configured to facilitate frictional engagement of track 160 with floor 20 of grain bin 12 to facilitate movement of remote operated vehicle 100 when tracks 160 are rotated. Such molded track or belt may also include a row of teeth extending along the length of the interior surface that are configured to engage sprocket(s) 162 to facilitate rotation of track 160 when sprocket(s) 162 are rotated. In some various different arrangements, track 160 may be formed of various different materials to provide suitable frictional engagement with floor 20 and sustain large stresses imposed by rotation of track 160 including but not limited to, for example, rubbers, polymers, fibers, and other reinforcement structures (e.g., steel belts).

Mounting assembly 166 is formed of any suitable size, shape, and design and is configured to position sprockets 162 and/or rollers 164 in position to hold track 160 thereon to form a rotating track and operably connect the rotating track 160 with main chassis 120.

In this example arrangement, as one example, mounting assembly 166 includes an elongated inner plate 182 and an elongated outer plate 184 extending from a forward end 186 to a rearward end 188. In this example arrangement, inner plate 182 and outer plate 184 are positioned on opposing sides of sprockets 162 and/or rollers 164. In one or more arrangements, as is shown, one or more spacers 190 are positioned between and operably connect inner plate 182 and outer plate 184. In this example arrangement, spacers 190 hold inner plate 182 and outer plate 184 at a sufficient distance to maintain operably connection with and facilitate smooth rotation of sprockets 162 and/or rollers 164.
In one or more arrangements, mounting assembly 166 is configured so that at least one sprockets 162 and/or rollers 164 and be repositioned so as to permit installation of and tensioning of track 160 on sprockets 162 and/or rollers 164 of drive assembly 122.

In an example arrangement shown, a roller 164 of drive assembly 122 is connected to plates 182/184 of mounting assembly 166 by extendable arms 194 having one or more bias members 196 configured to extend arms 194 and the connected roller 164 outward and thereby maintain tension on the track 160. Bias members 196 are formed of any suitable size, shape, and design and are configured to provide a bias force to extend arms 194 and the connected roller 164 outward from inner plate 182 and outer plate 184 in absence of an opposing force. In various different arrangements, bias members 196 may utilize various mechanisms to extend arms 194 and/or the connected roller 164/sprocket 162 outward including but not limited to, for example, one or more springs, one or more gas pistons, one or more gas springs, one or more hydraulic pistons, one or more actuators, one or more solenoids, one or more pneumatic members, compressible members, bands, and/or any other force generating means or combination thereof.

### Motor Assemblies 168:

Motor assemblies 168 are formed of any suitable size, shape, and design and are configured to operably connect with and rotate one or more sprockets 162 and/or rollers 164 of each drive assembly 122 to facilitate movement of remote operated vehicle 100.

In one or more arrangements, as is shown, motor assemblies 168 include respective motors 210 mechanically connected with the one or more sprockets 162 and/or rollers 164 of each drive assembly 122. In one or more arrangements, motors 210 are implemented using sealed electric motors (e.g. submersible waterproof motors) to prevent grain dust from entering an area of the motors where it can be ignited and cause an explosion in a grain bin (e.g., due to airborne grain dust generated in removal of grain 30 from the grain bin 12). However, the arrangements are not so limited. Rather, it is contemplated that in some various arrangements motors 210 may be implemented using various types of motors suited for driving drive assemblies 122 without significant risk of igniting dust and/or other combustibles in a grain bin 12.

In one or more arrangements, motor assemblies 168 include a gear assembly 212 operably connected between motor 210 and sprockets 162 and/or rollers 164 of the drive assembly 122. Gear assembly 212 is formed of any suitable size, shape, and design and is configured to transmit rotational energy and force from an output shaft of motor 210 to one or more sprockets 162 and/or rollers 164 of the drive assembly 122. In the arrangement shown, as one example, gear assembly 212 transfers rotation of the output shaft of motor 210 ninety degrees to an axle of a sprocket 162 used to drive track 160.

In some various arrangements, gear assembly 212 is configured to transfer rotational energy at a fixed gear ratio (e.g., 1:1, 1:2, 1:4, and/or any other ratio). Additionally or alternatively, in one or more arrangements, gear assembly 212 is configured to adjust its gear ratio dynamically during operation. For example, in one or more arrangements, gear assembly 212 may include a transmission (not shown) to facilitate adjustment of the gear ratio of gear assembly 212 during operation.

### Foldable Head Assembly 124:

Foldable head assembly 124 is formed of any suitable size, shape, and design and is configured to break up and move grain 30 toward air passageway assembly 126 or central removal point for removal (e.g., by vacuum).

In the arrangement shown, as one example foldable head assembly 124 includes a center section 220, a foldable left section 222, and a foldable right section 224. In this example arrangement, center section 220, a foldable left section 222, and a foldable right section 224 each include an elongated body 230 and a grain conveyor 232 positioned within the elongated body 230.

Body 230 is formed of any suitable size, shape, and design, and is configured to house and direct grain 30 toward grain conveyor 232 during operation for removal. In the arrangement shown, as one example, body 230 has an open front 240, through which grain 30 can flow into body 230, and extends between respective opposing ends 234 of the sections 220/222/224. In this example arrangement, left section 222 and right section 224 are operably connected to respective opposing ends 234 of center section 220 by hinges 248, so as to permit left section 222 and right section 224 to be folded upward. In the arrangement shown, bodies 230 of sections 220/222/224 have a curved scoop shape. However, the arrangements are not so limited. Rather, it is contemplated that in some various arrangements, bodies 230 of sections 220/222/224 may have various alternative shapes.

In the arrangement shown, body 230 of center section 220 has a rearward opening 242 for grain 30 to flow through and into a forward end 274 of air passageway assembly 126. However, the arrangements are not so limited. Rather, it is contemplated that in some various arrangements, foldable head assembly 124 may include additional or alternatively positioned openings to facilitate movement of grain 30 from foldable head assembly 124 into air passageway assembly 126.

### Actuators 250:

In one or more arrangements, foldable head assembly 124 includes actuators 250 to facilitate movement of left section 222 and right section 224. Actuators 250 are formed of any suitable size, shape, and design, and are configured to permit left section 222 and right section 224 to be remotely folded upward or unfolded downward during operation. In the arrangement shown, as one example, actuators 250 are double acting hydraulic cylinders 254 operably connected between body 230 of center section 220 and a respective lever arm 256 connected to body 230 of left section 222 and/or right section 224. However, the arrangements are not so limited. Rather, it is contemplated that in some various different arrangements actuators 250 may be implemented by various means and methods known in the art, including but not limited to, for example, various hydraulic driven actuators (e.g., hydraulic cylinders, gear pumps, piston pumps, hydraulic motors, etc), linear actuators, rotary actuators, motors, solenoids and other electro mechanical actuators, pneumatic actuators thermal and magnetic actuators, and/or polymer actuators, to name a few.

### Grain Conveyors 232:

Grain conveyors 232 are formed of any suitable size, shape, and design, and are configured to move grain 30 in bodies 230 of foldable head assembly 124 towards air passageway assembly 126 for removal.

In the arrangement shown, as one example, grain conveyors 232 are configured to move grain 30 in bodies 230 of foldable head assembly 124 toward rearward opening 242 of center section 220, which is operably connected to a forward end 274 of air passageway assembly 126.

In this example arrangement, grain conveyor 232 of left section 222 is configured to move grain 30 rightward and into center section 220. Conversely, grain conveyor 232 of right section 224 is configured to move grain 30 leftward and into center section 220. In this example arrangement, grain conveyor 232 of center section 220 is configured to move grain 30 inward to a center point at which the rearward opening 242 to air passageway assembly 126 is positioned.

In the example arrangement shown, grain conveyors 232 are auger type conveyors. However, the arrangements are not so limited. Rather, it is contemplated that in some various arrangements, grain conveyors 232 may be implemented using various methods and/or means including but not limited to, for example, augers, paddle sweeps, drag chains, conveyor belts, and/or any other method or means for grain transportation.

In the arrangement shown, auger type grain conveyors 232 are respectfully connected and held in place within each section 220/222/224 by a pair of axle mount arms 262 and bearings 264. In the arrangement shown, auger type grain conveyors 232 of left section 222 and right section 224 are configured to connect with auger type grain conveyor 232 of center section 220 when left section 222 and right section 224 are unfolded. Conversely, in this example, auger type grain conveyors 232 of left section 222 and right section 224 are configured to disconnect from auger type grain conveyor 232 of center section 220 when folded.

In the arrangement shown, as one example, the connecting and disconnecting of auger type grain conveyors 232 is accomplished by joint interconnects 268 positioned at opposing ends of the auger type grain conveyors 232 of the center section 220. In the arrangement shown, joint interconnects 268 are tongue and groove joints. However, the arrangements are not so limited. Rather, it is contemplated that in some various arrangements, joint interconnects 268 may be implemented using various types of interconnects, including but not limited to, for example, tongue and groove type joints, tracta joints, tripod joints, and/or various other CV joints and/or other types of interconnect joints.

### Air Passageway Assembly 126:

Air passageway assembly 126 is formed of any suitable size, shape, and design and is configured to provide a passageway for transportation of grain 30 by way of vacuum from a forward end 274, connected to rearward opening 242 of foldable head assembly 124, to a rearward end 276, where air passageway assembly 126 connects with vacuum hose 104. In the arrangement shown, air passageway assembly 126 has a generally circular shaped passageway with a rectangular shaped forward end 274, where air passageway assembly 126 connects with rearward opening 242. However, the arrangements are not so limited. Rather, it is contemplated that in some various arrangements, air passageway assembly 126 may include various additional or alternatively shaped passageways including by not limited to passageways that are circular, square, rectangular, triangular, or any other shape.

In one or more arrangements, air passageway assembly 126 includes a tail section 280 proximate to the rearward end 276. In the arrangement shown, as one example, tail section 280 is configured to pivot about a pivot point 282 to allow rearward end 276 and hose 104 to swing rightward and leftward to improve maneuverability of remote operated vehicle 100 while hose 104 is connected thereto.

### Brush Assemblies 128:

In one or more arrangements, remote operated vehicle 100 includes one or more brush assemblies 128. Brush assemblies 128 are formed of any suitable size, shape, and design, and are configured to direct grain 30 outward of the respective opposing ends 234 of the left section 222 and right section 224 of the foldable head assembly 124 into the pathway of foldable head assembly 124 for removal. Brush assemblies 128 may be useful, for example, to safely move grain 30 positioned close to a sidewall 16 of a grain bin 12 to a position where the grain 30 can be removed by foldable head assembly 124.

In the arrangement shown, as one example, remote operated vehicle 100 includes two brush assemblies 128 positioned proximate to outward ends 234 of foldable head assembly 124. However, the arrangements are not so limited. Rather, it is contemplated that various different embodiments may include any number of brush assemblies 128 at various additional or alternative positions to facilitate removal of grain 30. Further, system 10 may be operated without brush assemblies 128.

In the arrangement shown, as one example, brush assemblies 128 include a circular brush 290 and a motor 292 operably connected thereto so as to cause brush 290 to rotate when motor 292 is operated. In the arrangement shown, brush 290 of brush assembly 128 positioned adjacent a leftward end 234 of foldable head assembly 124 and is configured to rotate clockwise to direct grain 30 forward and rightward into the path of the foldable head assembly 124. Conversely, in the arrangement shown, brush 290 of brush assembly 128 positioned adjacent a rightward end 234 of foldable head assembly 124 and is configured to rotate counterclockwise to direct grain 30 forward and leftward into the path of the foldable head assembly 124.

In one or more arrangements, as is shown, brush assemblies 128 are operably connected to remote operated vehicle 100 by extendable mount arms 296. Extendable mount arms 296 are formed of any suitable size, shape, and design, and are configured to extend brush assemblies 128 outward to the side of foldable head assembly 124 and retract brush assemblies 128 inward toward foldable head assembly 124.

In the arrangement shown, extendable mount arms 296 include a set of telescoping actuators (e.g., hydraulic cylinders) that are operably connected between remote operated vehicle 100 and brush assemblies 128. However, the arrangements are not so limited. Rather, it is contemplated that in some various arrangements, extendable mount arms 296 may utilize mechanical arrangements and/or types of actuators to facilitate repositioning of brush assemblies 128 including but not limited to, for example, various hydraulic driven actuators (e.g., hydraulic cylinders, gear pumps, piston pumps, hydraulic motors, etc), linear actuators, rotary actuators, motors, solenoids and other electro mechanical actuators, pneumatic actuators thermal and magnetic actuators, and/or polymer actuators, to name a few.

In an alternative arrangement, brush assemblies 128 may be configured to be elongated members, similar to a conventional broom, positioned behind the foldable head assembly 124 to collect excess grain 30. In this alternate arrangement, brush assemblies 128 may extend from an end 234 of either the left section 222 and/or the right section 224 of the foldable head assembly 124 to any part of the forward end 274 of the air passageway assembly 126. This alternate configuration is configured to capture any excess grain 30 missed by the foldable head assembly 124 and redirect it to the air passageway assembly 126. Alternatively, any other method of capturing excess grain 30 to be removed from the grain bin 12 is hereby contemplated by this disclosure of brush assemblies 128.

### Lift Assembly 320:

In one or more arrangements, foldable head assembly 124 is operably connected to chassis 120 of remote operated vehicle 100 by lift assembly 320. Lift assembly 320 is formed of any suitable size, shape, and design and is configured to move foldable head assembly 124 between a lower position, where foldable head assembly 124 is adjacent to the floor 20 of grain bin 12, and an upper position, where foldable head assembly 124 is lifted a distance off of the floor 20. The ability to move foldable head assembly 124 to the upper position may be useful to facilitate easier transportation of remote operated vehicle 100 into and out of grain bin 12 prior to removal of grain 30.

In the arrangement shown, as one example, lift assembly 320 includes a set of arms 322, a set of rear brackets 332, and one or more actuators 338. Arms 322 are formed of any suitable size, shape, and design and are configured to operably connect foldable head assembly 124 with rear brackets 332 that are connected with chassis 120 and permit foldable head assembly 124 to move between the upper position and the lower position.

In the arrangement shown, as one example, arms 322 have an elongated shape extending between a forward end 324, where arms 322 are operably connected with foldable head assembly 124 (e.g., by fasteners, welding, adhesives, etc.), and a rearward end 326, where arms 322 are operably connected with rear brackets 332 and actuator(s) 338. In this example arrangement, an upper portion 328 of rearward end 326 is pivotally connected with a rear bracket 332 by a hinged connection 334 and rear bracket 332 is connected to chassis 120 (e.g., by fasteners, welding, adhesives, etc.).

In this example arrangement, a lower portion 330 of rearward end 326 is pivotally connected with an actuator 338 by a hinged connection 336. In operation, actuator 338 moves lower portion 330 of rearward end 326 forward and rearward relative to upper portion 328 of rearward end 326, which causes forward end 324 of arms 322 to be moved upward and downward to facilitate movement of foldable head assembly 124 between the upper position and the lower position.

### Sensors 130:

In some various different arrangements, remote operated vehicle 100 may include various different sensors 130 to facilitate reporting data regarding surroundings of vehicle 100 and/or status of various systems thereof to facilitate remote operation of vehicle by an operator. As some illustrative examples, such sensors may include but are not limited to, for example, cameras, doppler/micro-doppler RADAR, LIDAR, SONAR, temperature sensors, voltage sensors, position sensors, speed sensors, gyroscope sensors, accelerometers, and/or any other useful sensors.

### Control Circuit 132:

In one or more arrangements, remote operated vehicle 100 includes an onboard control circuit 132 to facilitate local control of various components of remote operated vehicle 100, for example, to facilitate navigation of vehicle 100 and operation of head assembly 124, brush assemblies 128, and/or other components in response to control signals received from control system 108. However, the arrangements are not so limited. Rather, it is contemplated that in some arrangements, various components of remote operated vehicle 100 may be configured to be controlled directly by control system 108 without an intermediary local control circuit 132.

### Grain Vacuum 102:

Grain vacuum 102 is formed of any suitable size, shape, and design and is configured to induce airflow through hose 104 to facilitate transportation of grain 30 from hose 104 by way of vacuum, and receive, gather and output grain 30 transported through hose 104. Grain vacuum 102 may be implemented using various different types of grain vacuums known in the art. Grain vacuums are commercially available from various manufacturers including but not limited to, for example, Brandt, Rem. Willinga, Conveyair, Kongskilde, and Farmking among other manufactures.

### Hose 104

Hose 104 is formed of any suitable size, shape, and design and is configured to provide a fluidic connection between a rearward end 276 of air passageway assembly 126 and grain vacuum 102 to facilitate removal of grain 30 through hose 104 by way of vacuum. In the arrangement shown, as one example, hose 104 is a generally flexible hose 104 having suitable rigidity to prevent the vacuum induced by grain vacuum 102 hose from collapsing hose 104. In one or more arrangements, one or more cables 302 are integrated with hose 104 to provide power to and/or facilitate communication with remote operated vehicle 100. cl Hose Coil 106
In one or more arrangements, system 10 includes a hose coil 106. Hose coil 106 is formed of any suitable size, shape, and design and is configured to receive and wind up hose 104 thereon for storage and/or transportation. In one or more arrangements, hose coil 106 is configured to automatically let out hose 104 to facilitate movement of remote operated vehicle 100 further away from hose coil 106 and take up excess hose 104 to facilitate movement of remote operated vehicle 100 closer to hose coil 106.

In one or more arrangements, hose coil 106 includes a base frame 312, a coil 314, and an actuator 316 (not shown), among other components. In this example arrangement, coil 314 is configured to rotate relative to base frame 312 and actuator 316 configured to rotate coil 314 to facilitate winding and unwinding of hose 104 during operation.

In one or more arrangements, as one example, actuator 316 is a bidirectional electric motor communicatively connected to and controllable by control system 108. However, the arrangements are not so limited. Rather, it is contemplated that in various different arrangements may be implemented using various additional or alternative types of actuators known in the art. In one or more arrangements, control system 108 is configured to automatically control hose coil 106 as remote operated vehicle 100 is operated/piloted by rotating coil 314 to facilitate winding and unwinding of hose 104 as may be necessary to accommodate movement of remote operated vehicle 100.

### Control System 108

In one or more arrangements, system 10 includes a control system 108. Control system 108 is formed of any suitable size, shape, and design and is configured to facilitate operation of remote operated vehicle 100 and/or other components of system 10 in response to signals from sensors (e.g., sensors 130) and/or input from a user interface 412. In the arrangement shown, as one example, control system 108 includes a control circuit 132, user interface 412, and or sensors 130, among other components.

### Processing System 400

In some various different arrangement, control system 108, control circuit 132 (and various other functional blocks, modules, controllers, devices, and/or circuits of system 10) may be implemented using various different types of electrical circuits, devices and/or systems (collectively “processing systems”) that are specifically configured to carry out one or more of these or related operations/activities. For example, such processing systems may include discrete logic circuits or programmable logic circuits configured for implementing these operations/activities, as shown in the figures and/or described in the specification. In certain embodiments, such a programmable logic circuit may include one or more programmable integrated circuits (e.g., field programmable gate arrays and/or programmable ICs). Additionally or alternatively, such a programmable logic circuit may include one or more processing circuits/devices (e.g., a computer, microcontroller, system-on-chip, smart phone, tablet, server, and/or cloud computing resources).

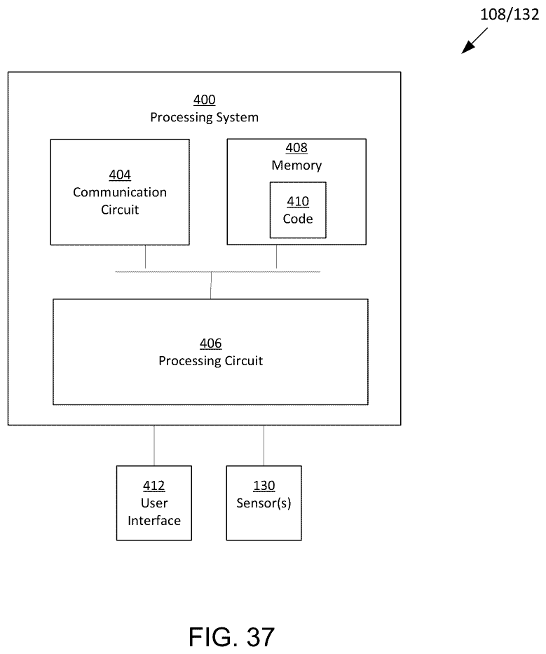

FIG. 37 shows a block level diagram of an example implementation of an example processing system 400 that may be used to implement control system 108, control circuit 132 (and various other functional blocks, modules, controllers, devices, and/or circuits of system 10), in accordance with one or more arrangements. In this example, processing system 400 has a communication circuit 404, a processing circuit 406, and a memory 408 having software code 410 or instructions that facilitates the operation of system 10, among other components.

Communication circuit 404 is formed of any suitable size, shape, design, technology, and in any arrangement and is configured to facilitate communication with devices to be controlled, monitored, and/or alerted by processing system 400. In one or more arrangements, as one example, communication circuit 404 includes a transmitter (for one-way communication) or transceiver (for two-way communication). In various arrangements, communication circuit 404 may be configured to communicate with various components of system 10 (e.g., using various wired and/or wireless communication technologies and protocols over various networks and/or mediums including but not limited to, for example, IsoBUS, Serial Data Interface 12 (SDI-12), UART, Serial Peripheral Interface, PCI/PCIe, Serial ATA, MODBUS RTU, ARM Advanced Microcontroller Bus Architecture (AMBA), USB, Firewire, RFID, MODBUS TCP, EtherNet/IP, Near Field Communication (NFC), infrared and optical communication, 802.3/Ethernet, 802.11/WIFI, Profibus, Wi-Max, Bluetooth, Bluetooth low energy, EtherCAT, Controller Area Network (CAN), UltraWideband (UWB), 802.15.4/ZigBee, ZWave, GSM/EDGE, UMTS/HSPA+/HSDPA, CDMA, LTE, RPMA, FM/VHF/UHF networks, and/or any other communication protocol, technology or network.

Processing circuit 406 may be any computing device that receives and processes information and outputs commands according to software code 410 stored in memory 408. For example, in some various arrangements, processing circuit 406 may be discrete logic circuits or programmable logic circuits configured for implementing these operations/activities, as shown in the figures and/or described in the specification. In certain arrangements, such a programmable circuit may include one or more programmable integrated circuits (e.g., field programmable gate arrays and/or programmable ICs). Additionally or alternatively, such a programmable circuit may include one or more processing circuits (e.g., a computer, microcontroller, system-on-chip, smart phone, server, and/or cloud computing resources). For instance, computer processing circuits may be programmed to execute a set (or sets) of software code 410 stored in and accessible from memory 408. Memory 408 may be any form of information storage such as flash memory, RAM memory, DRAM memory, a hard drive, or any other form of memory.

Processing circuit 406 and memory 408 may be formed of a single combined unit. Alternatively, processing circuit 406 and memory 408 may be formed of separate but electrically connected components. Alternatively, processing circuit 406 and memory 408 may each be formed of multiple separate but communicatively connected components.

Software code 410 is any form of instructions or rules that direct processing circuit 406 how to receive, interpret and respond to information to operate as described herein. Software code 410 or instructions are stored in memory 408 and accessible to processing circuit 406.

In some various arrangements, software code 410 is configured to cause processing system 400 to initiate various actions in response to signals from sensors (e.g., sensors 130) and/or input from a user interface 412 to facilitate remote operation of remote operated vehicle 100.

### User Interface 412:

User Interface 412 is formed of any suitable size, shape, design, technology, and in any arrangement and is configured to facilitate user control and/or adjustment of various components of system 10. In one or more arrangements, as one example, user interface 412 includes a set of inputs (not shown). Inputs are formed of any suitable size, shape, and design and are configured to facilitate user input of data and/or control commands. In various different arrangements, inputs may include various types of controls including but not limited to, for example, buttons, switches, dials, knobs, a keyboard, a mouse, a touch pad, a touchscreen, a joystick, a roller ball, and/or any other form of user input. Optionally, in one or more arrangements, user interface includes a display (not shown). Display is formed of any suitable size, shape, design, technology, and in any arrangement and is configured to facilitate display information of settings, sensor readings, time elapsed, and/or other information pertaining to proper storage of contents of grain bin 12. In one or more arrangements, display may include, for example, LED lights, meters, gauges, screen or monitor of a computing device, tablet, and/or smartphone. Additionally or alternatively, in one or more arrangements, the inputs and/or display may be implemented on a separate device that is communicatively connected to processing system 400. For example, in one or more arrangements, operation of processing system 400 may be customized using a smartphone or other computing device that is communicatively connected to the processing system 400 (e.g., via Bluetooth, WIFI, and/or the internet).

### In Operation

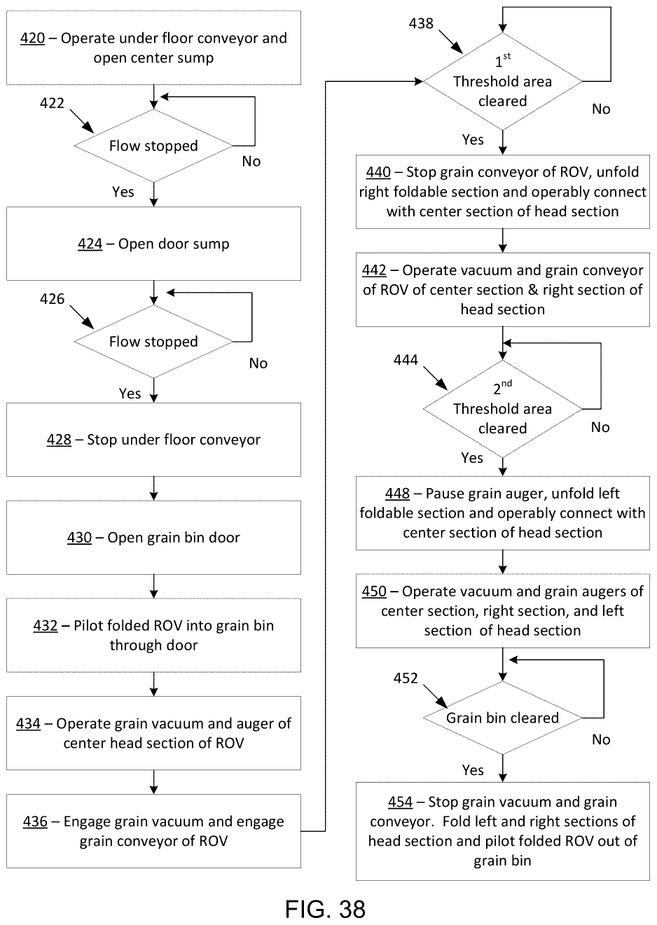

FIG. 38 shows an example process for removal of grain from a grain bin 12 using system 10 in accordance with one or more arrangements. In this illustrative example, the process starts at process block 420, where operation of an under floor conveyor 26 is initiated and a center sump 24 is opened. At decision block 422, the process is halted until flow of grain through the under floor conveyor 26 stops. At this point, grain 30 in the grain bin 12 has an inverse cone shape. The process then proceeds to process block 424, where one or more door sumps 24 are opened to clear grain 30 from an area adjacent to door 28 of the grain bin 12. The process halts at decision block 426 until the flow of grain through the under floor conveyor 26 stops. The under floor conveyor 26 is stopped at process block 428 and door 28 is opened at process block 430.

At process block 432, remote operated vehicle 100 with foldable head assembly 124 in the folded position is piloted through door 28 of the grain bin 12. At process block 436, grain vacuum 102 and grain conveyor 232 of center section 220 of foldable head assembly 124 are operated. While operating grain vacuum 102 and grain conveyor 232, remote operated vehicle 100 is piloted to drive foldable head assembly 124 into grain 30 to facilitate removal of grain 30 from the grain bin 12. Remote operated vehicle 100 may be piloted while foldable head assembly 124 is in the folded position or the unfolded position.

The process remains at decision block 438 until a first threshold area has been cleared of grain that would permit right section of 224 of foldable head assembly 124 to be unfolded. Once the first threshold area has been cleared, the process proceeds to process block 440, where grain conveyor 232 is stopped and right section 224 of foldable head assembly 124 is unfolded. The process then proceeds to process block 442, where grain conveyor 232 in center section 220 and right section 224 is operated along with grain vacuum 102. While operating grain vacuum 102 and grain conveyor 232, remote operated vehicle 100 is again piloted to drive foldable head assembly 124 into grain 30 to facilitate additional removal of grain 30 from the grain bin 12.

The process remains at decision block 444 until a second threshold area has been cleared of grain 30 that would permit left section of 222 of foldable head assembly 124 to be unfolded.

Once the second threshold area has been cleared, the process proceeds to process block 448, where grain conveyor 232 is stopped and left section 224 of foldable head assembly 124 is unfolded. The process then proceeds to process block 450, where grain conveyor 232 in center section 220, left section 222, and right section 224 are operated along with grain vacuum 102. While operating grain vacuum 102 and grain conveyor 232, remote operated vehicle 100 is again piloted to drive foldable head assembly 124 into grain 30 to facilitate additional removal of grain from the grain bin 12. Optionally, brush assemblies 128 positioned on the side of or adjacent to foldable head assembly 124 may be operated to help direct grain 30 into the path of foldable head assembly 124.

The process continues in this manner at decision block 452 until grain bin 12 has been substantially cleared of grain 30 or the operator is satisfied with the grain 30 which has been removed from the grain bin. At which point, the process proceeds to process block 454, grain vacuum 102 and grain conveyor 232 are stopped and left section 222 and right section 224 of foldable head assembly 124 are moved to the folded position. With left section 222 and right section 224 of foldable head assembly 124 in the folded position, the remote operated vehicle 100 is then piloted out through door 28 of the grain bin 12.

From the above discussion it will be appreciated that the sweep system for grain bins 12 improves upon the state of the art. More specifically, and without limitation, it will be appreciated that in one or more arrangements a remote operated vehicle based system for removal of grain from grain bins is provided: that reduces or eliminates the need for a user to enter the grain bin; that effectively removes the vast majority of grain from the grain bin; that is efficient to use; that reduces equipment costs; that can be used with any grain bin; that that works effectively; that is robust; and/or that is durable, among other advantages and improvements.

It will be appreciated by those skilled in the art that other various modifications could be made to the device without parting from the spirit and scope of this disclosure. All such modifications and changes fall within the scope of the claims and are intended to be covered thereby.

### SELECTED REFERENCE NUMBERS

10—System
12—Grain Bin
14—Foundation (of Grain Bin 12)
16—Sidewall (of Grain Bin 12)
18—Roof (of Grain Bin 12)
20—Floor (of Grain Bin 12)
24—Sump(s) (of Grain Bin 12)
26—Grain Conveyor (of Grain Bin 12)
28—Door (of Grain Bin 12)
30—Grain
100—Remote Operated Vehicle
102—Grain Vacuum
104—Hose
106—Actuated Hose Coil
108—Control System
120—Main Chassis
122—Drive Assemblies
124—Foldable Head Assembly
126—Air Passageway Assembly
128—Brush Assemblies
130—Sensors
132—Control Circuit
140—Head End (of Chassis 120)
142—Tail End (of Chassis 120)
144—Opposing sides (of Chassis 120)
160—Tracks (of Drive Assemblies 122)
162—Sprockets (of Drive Assemblies 122)
164—Rollers (of Drive Assemblies 122)
166—Mounting Assembly (of Drive Assemblies 122)
168—Motor Assemblies (of Drive Assemblies 122)
174—Chain Links (of Tracks 160)
176—Plates (of Tracks 160)
182—Inner Plate (of Mounting Assembly 166)
184—Outer Plate (of Mounting Assembly 166)
186—Forward Ends (of Plates 182/184)
188—Rearward Ends (of Plates 182/184)
190—Spacers (of Mounting Assembly 166)
194—Extendable Arms (of Mounting Assembly 166)
196—Bias Members (of Extendable Arms 194)
210—Motors
212—Gear Assemblies
220—Center Section
222—Foldable Left Section
224—Foldable Right Section
230—Elongated Body (of Sections 220/222/224)
232—Grain Conveyor
234—Opposing Ends.
240—Open Front (of Elongated Body 230)
242—Rearward Opening
248—Hinges
250—Actuators
254—Hydraulic cylinders
256—Lever Arm
262—Axle mount arms
264—Bearings
268—Joint Interconnects
274—Forward End (of Air passageway assembly 126)
276—Rearward End (of Air passageway assembly 126)
280—Tail Section (of Air passageway assembly 126)
282—Pivot Point (of Tail Section 280)
290—Brush (of Brush Assemblies 124)
292—Motor (of Brush Assemblies 124)
296—Extendable Mount Arms (of Brush Assemblies 124)
302—Cables (of Hose 104)
312—Base Frame (of Hose Coil 106)
314—Coil (of Hose Coil 106)
316—Actuator
320—Lift Assembly
322—Arms
324—Forward End (of Arms 322)
326—Rearward End (of Arms 322)
328—Upper Portion (of Rearward End 326)
330—Lower Portion (of Rearward End 326)
332—Rear brackets
334—Hinge
336—Hinge
338—Actuator
400—Processing System
404—Communication Circuit (of Processing System 400)
406—Processing Circuit (of Processing System 400)
408—Memory (of Processing System 400)
410—Software Code (of Processing System 400)
412—User Interface (of Processing System 400)
420—Process Block
422—Decision Block
424—Process Block
426—Decision Block
428—Process Block
430—Process Block
432—Process Block
434—Process Block
436—Process Block
438—Decision Block
440—Process Block
442—Process Block
444—Decision Block
446—Process Block
448—Process Block
450—Process Block
452—Decision Block
454—Process Block

What is claimed

1. A remote operated vehicle for removal of grain from a grain bin, comprising:
a chassis;
a drive system;
a head assembly operably connected to the chassis;
wherein the head assembly has an elongated body with an open front;
wherein the head assembly has a rearward opening;
wherein the head assembly includes a grain conveyor positioned within the elongated body;
wherein the grain conveyor is configured to move grain that enters the elongated body through the open front to the rearward opening;
an air passageway assembly;
the air passageway assembly configured to provide a fluidic connection between the rearward opening and a vacuum hose to facilitate removal of grain through the air passageway assembly and vacuum hose by way of vacuum.

2. The remote operated vehicle of claim 1, wherein the head assembly is a foldable head assembly.

3. The remote operated vehicle of claim 1, wherein the head assembly includes a center section, a foldable right section, and a foldable left section.

4. The remote operated vehicle of claim 1, wherein the head assembly includes:
a center section;
a right section hingedly connected to the center section;
a left section hingedly connected to the center section;
a set of actuators configured to move the right section and the left section between a folded position and an unfolded position.

5. The remote operated vehicle of claim 1, wherein the grain conveyor is an auger.

6. The remote operated vehicle of claim 1, wherein the head assembly includes:
a center section;
a right section hingedly connected to the center section;
a left section hingedly connected to the center section;
a set of actuators configured to move the right section and the left section between a folded position and an unfolded position;
wherein the grain conveyor includes a center auger positioned in the center section, a left auger positioned in the left section, and a right auger positioned in the right section;
wherein the grain conveyor has a set of joint interconnects configured to permit the left auger and the right auger to disconnect from the center auger when the right section and the left section are moved to the folded position.

7. The remote operated vehicle of claim 1, further comprising a lift assembly;
wherein the lift assembly is configured to move the head assembly between an upper position and a lower position.

8. The remote operated vehicle of claim 1, wherein the drive system includes a pair of track assemblies.

9. The remote operated vehicle of claim 1, wherein the drive system includes a pair of track
assemblies;
wherein the drive system includes a set of motors configured to drive the track assemblies;
wherein the set of motors are sealed to prevent dust and/or debris from entering the set of motors.

10. The remote operated vehicle of claim 1, wherein the drive system includes a pair of track assemblies;
wherein the drive system includes a set of motors configured to drive the track assemblies;
wherein the set of motors are sealed submersible motors so as to prevent dust and/or debris from entering the set of motors.

11. The remote operated vehicle of claim 1, further comprising at least one brush assembly, positioned adjacent the head assembly.

12. A system for removal of grain from a grain bin, comprising:
a grain vacuum;
a remote operated vehicle;
a vacuum hose fluidically connecting the remote operated vehicle to the grain vacuum;
wherein the remote operated vehicle includes:
a chassis;
a drive system;
a head assembly operably connected to the chassis;
wherein the head assembly has an elongated body with an open front;
wherein the head assembly has a rearward opening;
wherein the head assembly includes a grain conveyor positioned within the elongated body;
wherein the grain conveyor is configured to move grain that enters the elongated body through the open front to the rearward opening;
an air passageway assembly;
the air passageway assembly configured to provide a fluidic connection between the rearward opening and the vacuum hose to facilitate removal of grain through the air passageway assembly and vacuum hose by way of vacuum.

13. The system of claim 12, wherein the head assembly is a foldable head assembly.

14. The system of claim 12, wherein the head assembly includes a center section, a foldable right section, and a foldable left section.

15. The system of claim 12, wherein the head assembly includes:
a center section;
a right section hingedly connected to the center section;
a left section hingedly connected to the center section;
a set of actuators configured to move the right section and the left section between a folded position and an unfolded position.

16. The system of claim 12, wherein the grain conveyor is an auger.

17. The system of claim 12, wherein the head assembly includes:
a center section;
a right section hingedly connected to the center section;
a left section hingedly connected to the center section;
a set of actuators configured to move the right section and the left section between a folded position and an unfolded position;
wherein the grain conveyor includes a center auger positioned in the center section, a left auger positioned in the left section, and a right auger positioned in the right section;
wherein the grain conveyor has a set of joint interconnects configured to permit the left auger and the right auger to disconnect from the center auger when the right section and the left section are moved to the folded position.

18. The system of claim 12, further comprising a lift assembly;
wherein the lift assembly is configured to move the head assembly between an upper position and a lower position.

19. The system of claim 12, wherein the drive system includes a pair of track assemblies.

20. The system of claim 12, wherein the drive system includes a pair of track assemblies;
wherein the drive system includes a set of motors configured to drive the track assemblies;
wherein the set of motors are sealed to prevent dust and/or debris from entering the set of motors.

21. The system of claim 12, wherein the drive system includes a pair of track assemblies;
wherein the drive system includes a set of motors configured to drive the track assemblies;
wherein the set of motors are sealed submersible motors so as to prevent dust and/or debris from entering the set of motors.

22. The system of claim 12, further comprising at least one brush assembly, positioned adjacent the head assembly.

23. A method for removal of grain from a grain bin, comprising:
fluidically connecting a vacuum via a hose to a remote operated vehicle;
moving the remote operated vehicle through a door of a grain bin;
piloting the remote operated vehicle around an interior floor of the grain bin to facilitate removal of grain from the grain bin through the hose and to the vacuum;
removing the remote operated vehicle from the door of the grain bin after the desired amount of grain has been removed from the grain bin.

24. The method of claim 23, wherein the remote operated vehicle further comprises:
a foldable head assembly;
the foldable head assembly having a center section, a right section hingedly connected to the center section, and a left section hingedly connected to the center section;
a set of actuators configured to move the right section and the left section between a folded position and an unfolded position when the remote operated vehicle is in the grain bin.

25. The method of claim 23, wherein the remote operated vehicle further comprises a foldable head assembly; wherein the foldable head assembly is in a folded position while the remote operated vehicle is moved through the door of the grain bin.

26. The method of claim 23, wherein the remote operated vehicle further comprises a foldable head assembly; wherein the foldable head assembly is in a folded position while the remote operated vehicle is moved through the door of the grain bin; wherein the foldable head assembly is in an unfolded position while the remote operated vehicle is in operation inside the grain bin.

27. The method of claim 23, wherein moving the remote operated vehicle includes driving the remote operated vehicle under its own power.

28. The method of claim 23, wherein grain is removed from the grain bin through an air passageway assembly of the remote operated vehicle and the hose via suction provided by the vacuum.
